(19) United States
(12) Patent Application Publication
(10) Pub. No.: US 2021/0037724 A1
(43) Pub. Date: Feb. 11, 2021

(54) PLANT GROWTH PROPAGATION SYSTEM

(71) Applicant: Jiffy International AS, Kristiansand (NO)

(72) Inventors: Herald Reiersen, Lorain, OH (US); Martin Muilenburg, Lorain, OH (US); Anno Hermes, Lorain, OH (US); Cees de Bakker, Lorain, OH (US)

(73) Assignee: Jiffy International AS, Kristiansand (NO)

(21) Appl. No.: 16/979,362

(22) PCT Filed: Apr. 18, 2019
(86) PCT No.: PCT/IB2019/053230

§ 371 Date: Sep. 9, 2020

Related U.S. Application Data
(60) Provisional application No. 62/659,829, filed on Apr. 19, 2018.

(51) Int. Cl. A01G 24/46; A01G 24/28; A01G 24/25; A01G 24/23; A01G 24/27; A01G 24/15

(52) U.S. Cl. CPC A01G 24/46; A01G 24/28; A01G 24/15; A01G 24/23; A01G 24/27; A01G 24/25

(57) ABSTRACT

Systems, methods, and kits for plant propagation are disclosed. In some embodiments, the systems, methods, and kits for plant propagation involve a plug, a wrap, and a container. The container is configured to house the plug with a plant growing therein, where the plug is encircled by the wrap within the container, and where the plug and the wrap may include the same material.

### RELATED APPLICATIONS

This application claims priority to U.S. Provisional Application No. 62/659,829 filed under 35 U.S.C. § 111(b) on Apr. 19, 2018, the disclosure of which is incorporated herein by reference in its entirety.

### BACKGROUND

Orchids are slow-growing plants that utilize large plugs. Current jumbo plugs are made by filling two forms with a slurry. This can be a cumbersome process. There is a need in the art for new and improved plant growth propagation systems specifically designed for the growth of orchids.

### SUMMARY

Provided is a system for plant propagation comprising a plug comprising a first plant growth substrate mix, a wrap having a first side and a second side and comprising a second plant growth substrate mix, where the wrap defines a plurality of channels in the first side, and a container configured to house the plug with a plant growing therein, where the wrap is configured to be wrapped around the plug in the container such that the first side is in direct contact with the plug or roots of a plant growing in the plug. In certain embodiments, the plant is an orchid.

In certain embodiments, the first side is arcuate, and the second side is arcuate. In certain embodiments, the wrap has a half-moon shape.

In certain embodiments, the wrap comprises a single, bendable piece of the second plant growth substrate mix. In certain embodiments, the wrap comprises two or more wrap segments configured to fit together and substantially encircle the plug. In certain embodiments, the first plant growth substrate mix has about 50% identity in composition to the second plant growth substrate mix. In certain embodiments, the first plant growth substrate mix is identical to the second plant growth substrate mix.

In certain embodiments, the system further comprises a circular bottom comprising either of the first plant growth substrate mix or the second plant growth substrate mix, where the circular bottom is configured to be disposed in the container below the plug. In certain embodiments, the system further comprises a circular bottom comprising a fleece cloth or coco fiber mat.

In certain embodiments, at least one of the first plant growth substrate mix or second plant growth substrate mix comprises peat, coir, pine or other barks, perlite, compost, fertilizers, minerals such as vermiculite, manure, granulated lava, pumice, burnt or calcined clay, mineral fibers, Sphagnum moss, Hypnaceous moss, rice hulls, bagasse, sand, perlite, leaf mold, gypsum, limestone, clay, cellulose fibers, lignocellulose fibers, or combinations thereof.

In certain embodiments, at least one of the first plant growth substrate mix or the second plant growth substrate mix comprises polyurethane, polyvinyl alcohol (PVA), polyvinyl acetate (PVAC), clay, a crosslinker, an accelerator, a plasticizer, a pH buffer, expanded polystyrene, urea formaldehyde, or a microelement.

In certain embodiments, one of the first or second plant growth substrate mixes comprises a hydrophilic polyurethane prepolymer. In particular embodiments, the hydrophilic polyurethane prepolymer comprises a reaction product of a polyol with a polyisocyanate. In particular embodiments, the polyol is a polyoxyethylene polyol. In particular embodiments, the first or second plant growth substrate mix comprises prepolymer to aggregate in a ratio of from about 0.02:1 to about 0.14:1.

In certain embodiments, the slits have a rectangular cross section. In certain embodiments, the slits have a triangular cross section. In certain embodiments, the slits comprise incisions that do not extend fully through a thickness of the wrap.

Further provided is a system for plant propagation comprising a plug comprising a first plant growth substrate mix; a wrap having a first side and a second side and comprising a second plant growth substrate mix, wherein the wrap defines a plurality of slits in the first side, wherein the slits separate rectangular protrusions of the second plant growth substrate mix that extend from the second side to the first side; and a container configured to house the plug with a plant growing therein, wherein the wrap is configured to be wrapped around the plug in the container such that the second side is in direct contact with the plug or roots of a plant growing in the plug.

In certain embodiments, the slits separate rectangular protrusions of the second plant growth substrate mix.

Further provided is a system for plant propagation comprising a plug comprising a first plant growth substrate mix, a wrap comprising a plurality of wrap segments comprising a second plant growth substrate mix, each wrap segment having a first side and a second side, the second side of at least one of the wrap segments comprising a ledge configured to support the plug, and a container configured to house the plug with a plant growing therein, wherein the wrap segments are configured to be wrapped around the plug in the container such that the first side faces the container and the second side is in direct contact with the plug or roots of a plant growing in the plug. In certain embodiments, the at least one wrap segment has an L-shape.

Further provided is a system for plant propagation comprising a plug comprising a plant growth substrate mix, a wrap comprising the plant growth substrate mix and having a first side and a second side, where the first side defines a plurality of slits, and a container configured to house the plug with a plant growing therein, where the wrap is configured to be wrapped around the plug in the container such that the first side is in direct contact with the plug or roots of a plant growing in the plug. In certain embodiments, the plant is an orchid.

In certain embodiments, the wrap consists essentially of the plant growth substrate mix. In particular embodiments, the plug consists essentially of the plant growth substrate mix.

In certain embodiments, the slits are latitudinal. In certain embodiments, each of the plurality of slits extends across a width of the wrap.

In certain embodiments, the wrap comprises a single, bendable piece of the plant growth substrate. In certain embodiments, the wrap comprises two or more wrap segments configured to fit together in the container and substantially encircle the plug.

In certain embodiments, the first side is arcuate, and the second side is arcuate, the wrap thereby having a half-moon shape.

Further provided is a system for plant propagation comprising a plug consisting essentially of a plant growth substrate mix, a wrap consisting essentially of the plant growth substrate mix, and a container configured to house the plug with a plant growing therein, where the wrap is configured to be wrapped around the plug in the container. In certain embodiments, the plant is an orchid.

Further provided is a method for propagating a plant, the method comprising growing a plant seedling in a plug comprising a plant growth substrate mix until the plant seedling develops roots protruding from the plug, surrounding the plug with a wrap comprising the plant growth substrate mix to form a wrapped plug, where the wrap comprises a plurality of slits, and configuring the wrapped plug in a container for further growth of the plant. In certain embodiments, the plant is an orchid.

Further provided is a kit for plant propagation, the kit comprising a first package housing a plug comprising a plant growth substrate mix, a second package housing a wrap comprising the plant growth substrate mix, and a container configured to house the plug and the wrap. In certain embodiments, the kit further comprises seeds, cuttings, or tissue cultures. In particular embodiments, the kit comprises orchid tissue cultures.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Perspective side view of a system for plant propagation that includes a plug, a wrap, and a container.

FIG. 2: Top-down view of a system for plant propagation that includes a plug, a wrap, and a container.

FIG. 3: Perspective side view of a wrap of a system for plant propagation that includes a plug, a wrap, and a container.

FIG. 4: Side view of a wrap of a system for plant propagation that includes a plug, a wrap, and a container.

FIG. 5: Side view of an alternative embodiment of a wrap of a system for plant propagation.

FIG. 6: Photograph showing a mold filled with wraps containing slits.

FIG. 7: Photograph showing a system for plant propagation that includes a plug, a container, and a wrap containing slits.

FIG. 8: Photograph showing a plug with an orchid growing in it and a half-moon shaped wrap segment with slits. The wrap completely encircles and covers the roots on the outside the plug, and facilitates an easy transition into like-type material.

FIG. 9: Photograph of a system made with two half-moon shaped wrap segments, with an orchid growing in a plug encircled by the wrap segments, in a container. The roots of the orchid were fully intact.

FIG. 10: Photograph showing the root structure of an orchid in a plug.

FIG. 11: Photograph of an orchid growing in a system for plant propagation.

FIG. 12: Photograph of an orchid rooted in a plug set on a wrap, prior to being inserted into a container and encircling the plug with the wrap.

FIGS. 13A-13C: Top (FIG. 13A), side elevational (FIG. 13B), and side (FIG. 13C) views of a production tray for making wraps of plant growth substrate mix.

FIGS. 14A-14D: Side elevational (FIG. 14A), side (FIGS. 14B-14C), and top (FIG. 14D) views of a production tray for making wraps of a plant growth substrate mix.

FIG. 15: Photograph of a wrap segment.

FIG. 16: Photograph of two wrap segments being held together.

FIG. 17: Photograph of a system having a plug substantially encircled by a wrap composed of two wrap segments, inside a container.

FIG. 18: Photograph of a wrap.

FIG. 19: Photograph of single-piece wraps inside containers.

FIGS. 20A-20E: Side elevational view (FIG. 20A), two top views (FIGS. 20B-20C), and two side views (FIGS. 20D-20E) of a mold that can be used to make wrap segments having incisions.

FIG. 21: Top-down view of a system for plant propagation that includes a wrap composed of a first wrap segment and a second wrap segment.

FIG. 22: Top-down view photograph showing a system for plant propagation that includes two semicircular wrap segments and a plug. The container for the system is not shown in this photograph.

FIG. 23: Photograph showing two sets of semicircular wrap segments in containers, one of which (on the left in the photograph) further includes a plug encircled by the wrap segments and one of which (on the right in the photograph) does not.

FIG. 24: 3D-printed mold for substrate mixes to make a crescent-shaped wrap segment.

FIG. 25: Side view of alternative embodiment of wrap segments.

FIGS. 26A-26D: Photographs of a non-limiting example system for plant propagation. FIG. 26A shows two wrap segments in isolation. FIG. 26B shows an orchid in a plug sitting on one of the wrap segments. FIG. 26C shows an orchid in a plug wrapped within the wrap segments and contained within a container. FIG. 26D is a close-up of the container housing the orchid, plug, and wrap segments.

FIG. 27: Photograph showing the root structure of an orchid in a plug.

FIG. 28: Perspective view of an alternative embodiment of a wrap having incisions.

FIGS. 29A-29C: Photographs of an alternative embodiment of a wrap configured to hold a plurality of rooted plants (FIG. 29A), a mold used to make the wrap (FIG. 29B), and the wrap holding 3 rooted lilies in the cavity of a tray (FIG. 29C).

FIG. 30: Side view of an alternative embodiment of a wrap having large incisions forming rectangular teeth.

FIG. 31: Top-down view of a system utilizing a wrap having large incisions forming rectangular teeth.

FIGS. 32A-32C: Photographs of an alternative embodiment of a wrap configured to allow more air into a container (FIG. 32A), the wrap surrounding a plug and inserted in a container (FIG. 32B), and a mold used to make such a wrap (FIG. 32C).

FIG. 33: Side view of an alternative embodiment of a wrap composed of wrap segments having ledges.

FIG. 34: Side view of a system for plant propagation having a wrap composed of wrap segments with ledges.

FIGS. 35A-35C: Photographs of an alternative embodiment of a wrap with a plug resting on ledges (FIG. 35A), a system utilizing such a wrap with a plug in a container (FIG. 35B), and a mold that can be used to make such a wrap (FIG. 35C).

FIG. 36: Photograph of orchids in plugs in containers.

FIG. 37: Photograph of production tray used to make rectangular single-piece wraps.

FIG. 38: Photograph showing non-limiting examples of containers having holes for drainage.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein are systems and methods for plant propagation. In general, a system for plant propagation may include a wrap composed of a plant growth substrate mix, a plug composed of a plant growth substrate mix, and a container configured to house the wrap and the plug, where a plant may be growing in the plug. The plug may be encircled or substantially encircled by the wrap, and the resulting wrapped plug can be disposed within the container. In some embodiments, the wrapped plug fits snugly within the container, which may be a pot or a tray having one or more cavities. In some embodiments, the wrap is oversized so as to result in there being substantially no air in the container. However, in some embodiments, the wrap fits loosely in the container and allows for more air to enter the container. Advantageously, in some embodiments, the plant growth substrate mix of the plug is the same as the plant growth substrate mix as the wrap. As described in more detail below, this aids in root development. However, it is not strictly necessary that the plant growth substrate mix of the plug be identical to the plant growth substrate mix of the wrap. For example, the first plant growth substrate mix may be about 50% identical to the plant growth substrate mix. Or, the first plant growth substrate mix may be only about 10% identical to the plant growth substrate mix. In other embodiments, the plant growth substrate mix of the plug is entirely different from the plant growth substrate mix of the wrap.

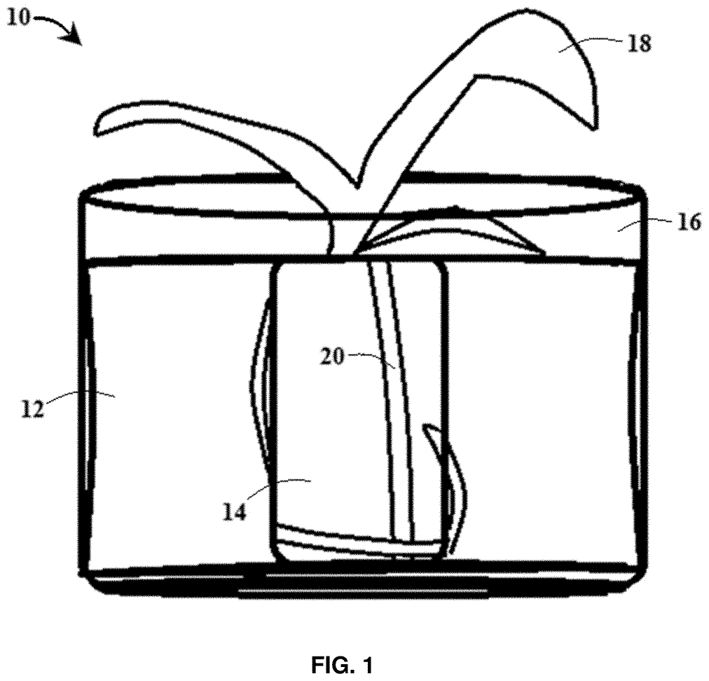

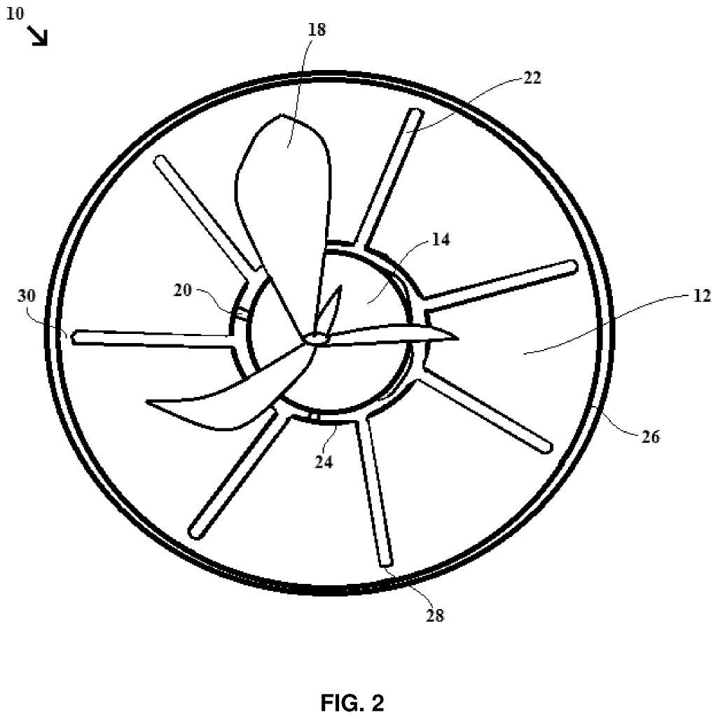

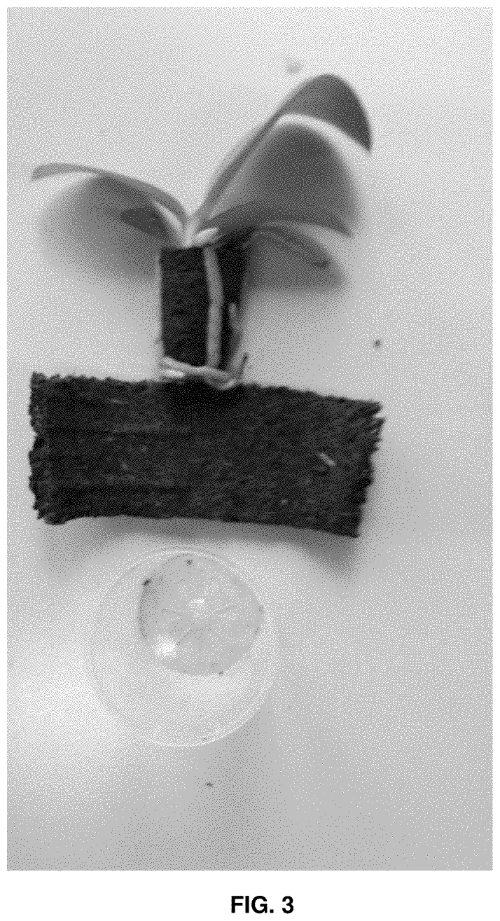

Referring now to FIGS. 1-2, an example system 10 includes a wrap 12, a plug 14, and a container 16. A plant 18 may grow in the plug 14, which is encircled by the wrap 12 within the container 16. The wrap 12 may fit snugly within the container 16, which, in this example system 10, is a plant pot. The plant's roots 20 may protrude from the plug 14 and contact the wrap 12. Notably, the wrap 12 wraps around the plug 14 in which the plant 18 is growing, not directly around the plant 18 itself (other than some of its roots). In some embodiments, the wrap 12 is a bendable piece of plant growth substrate mix that includes channels or slits 22 on a first side 24. As seen in FIG. 2, the first side 24 is in direct contact with the roots 20 and/or the plug 14. As seen in FIG. 2, slits 22 are present in the wrap 12 extending inwardly from the first side 24. The slits 22 may enhance drainage within the system 10. FIG. 3 shows a photograph of an example system 10 where the wrap 12, the plug 14, and the container 16 are shown in isolation (i.e., the wrap 12 and 14 have not been inserted into the container 16).

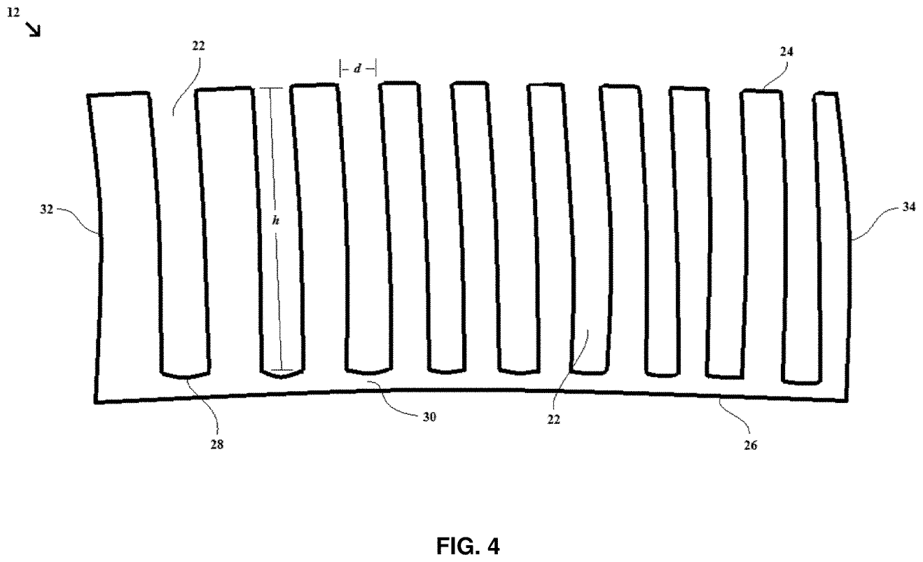

Referring now to FIG. 4, a side view of an embodiment of the wrap 12 is shown. The number and dimensions of the slits 22 shown in FIG. 4 may be greater than optimal for ease of illustration and explanation. It is understood that the number and dimensions of the slits 22 in the wrap 12 may vary. The wrap 12 includes a first side 24 and a second side 26, and extends from a first end 32 to a second end 34. The first side 24 defines a plurality of slits 22. Each slit 22 extends from the first side 24 to a bottom 28 at a certain depth within the wrap 12. The height h of each slit 22 within the wrap 12 may vary. However, drainage within the system 10 is enhanced by increasing the height h of the slits 22 as much as possible while still preserving the stability of the wrap 12. In other words, the bottoms 28 of the slits 22 are generally not deep enough to cause breakage of the wrap 12. The slits 22 in the wrap 12 should allow the wrap 12 to fold without the wrap 12 breaking into pieces, and as such have an acceptable fit around the plug 14 in the container 16. Enough space remains in the area 30 of the wrap 12 between the bottom 28 of the slits 22 and the second side 26 of the wrap 12 to prevent the wrap 12 from falling apart when the wrap 12 is folded, such as when the wrap 12 is folded to fit within the container 16.

Any number of slits 22 within the wrap 12 is possible. When the wrap 12 encircles the plug 14, the first side 24, having the slits 22, may face and be in direct contact with the plug 14 and/or the roots 20 of the plant 18 growing in the plug 14. The slits 22 may provide for enhanced root development by enhancing drainage within the system 10. The plant 18 may be allowed to propagate in the system 10 for any desired period of time.

Referring again to FIG. 4, the slits 22 can each have the same diameter d, or may have a variety of diameters. In other words, the wrap 12 may have a plurality of slits 22 each having the same diameter d, or may have several slits 22 with a first diameter and at least one slit 22 with a second diameter, where the first and second diameters are different, or may have a plurality of slits 22 each having a different diameter. The same is true for the spacing between slits 22. The spacing between slits 22 may be the same between every two slits 22 or may vary between adjacent slits 22 one or more times on the same wrap 12. Similarly, as noted above, the height h of the slits 22 may vary as between slits 22 within the wrap 12.

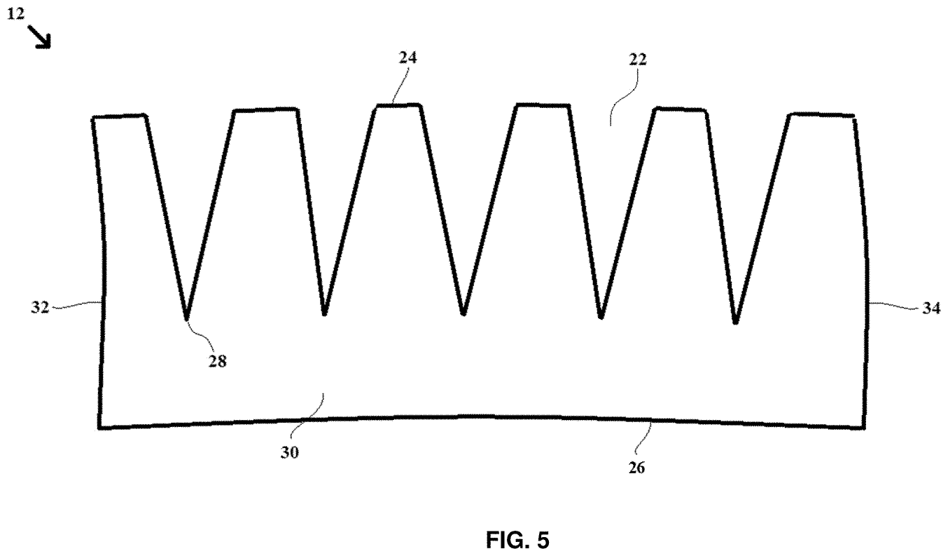

As seen in FIG. 4, the slits 22 may generally form rectangular cross sections. However, as seen in FIG. 5, an alternative embodiment of the wrap 12 may include slits 22 that form triangular cross sections. Thus, the cross sectional shape of the slits 22 in the wrap 12 is not particularly limited. Despite the cross sectional shape of the slits 22, the area 30 between the bottoms 28 of the slits 22 and the second side 26 is large enough to prevent the wrap 12 from breaking apart when the wrap 12 is folded to fit within the container 16.

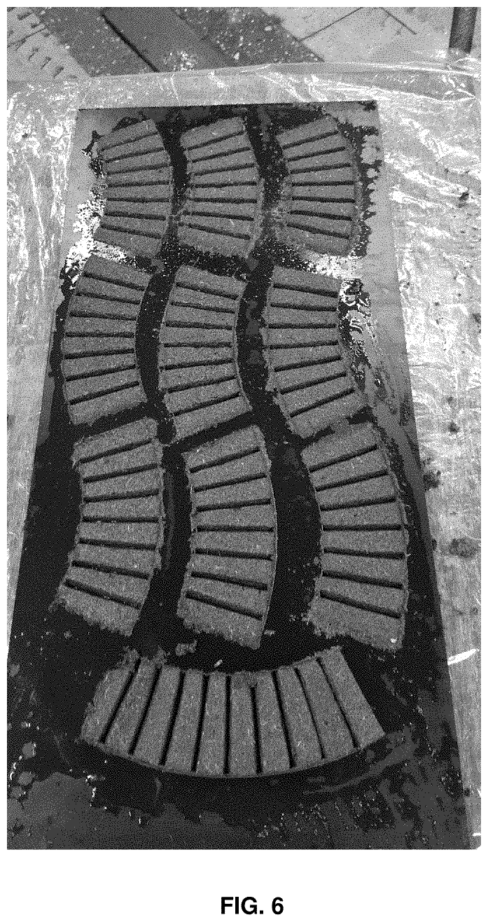

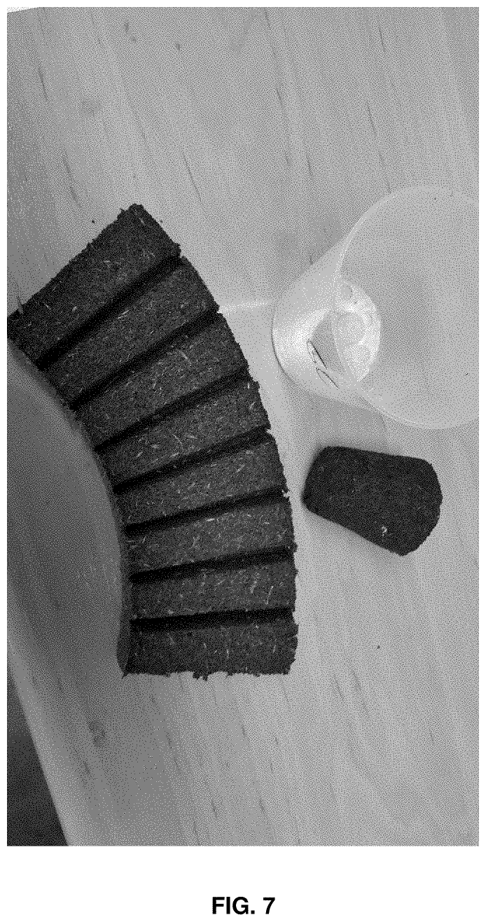

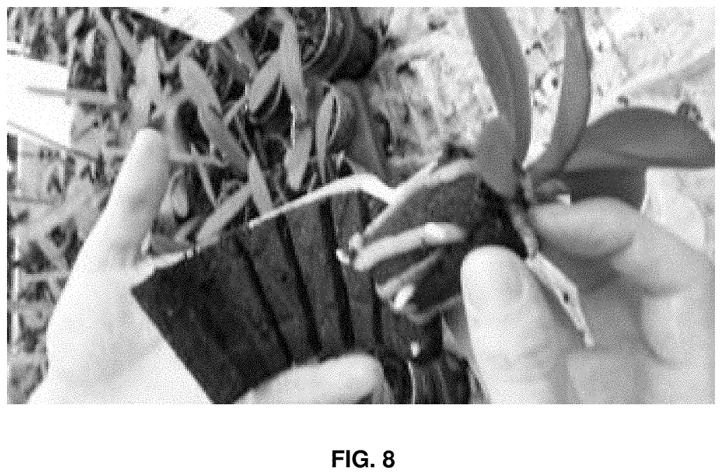

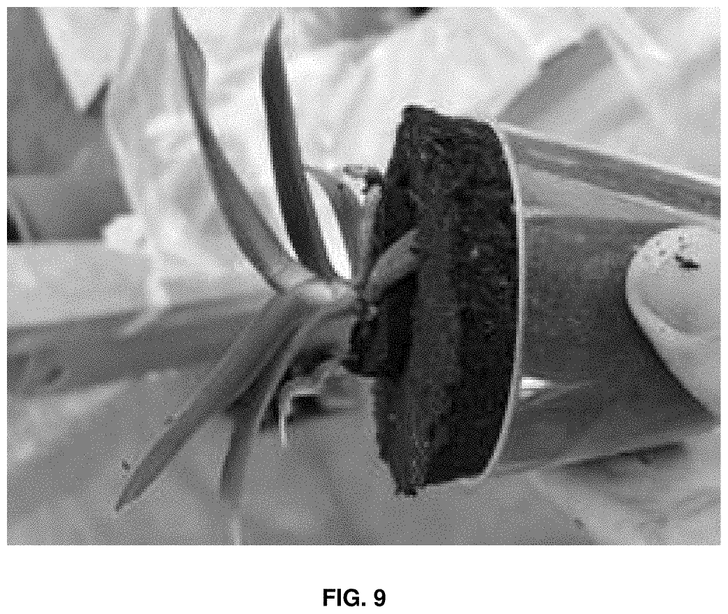

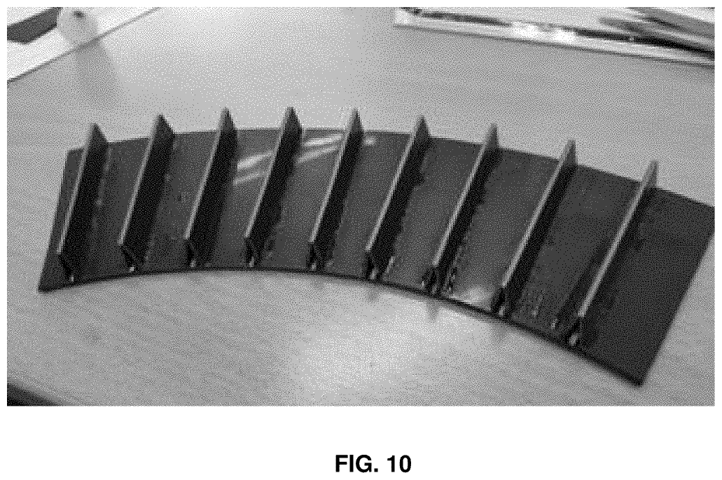

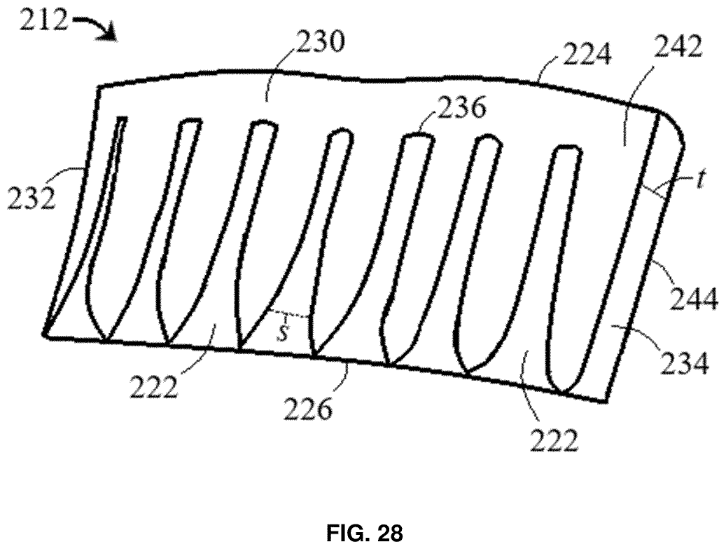

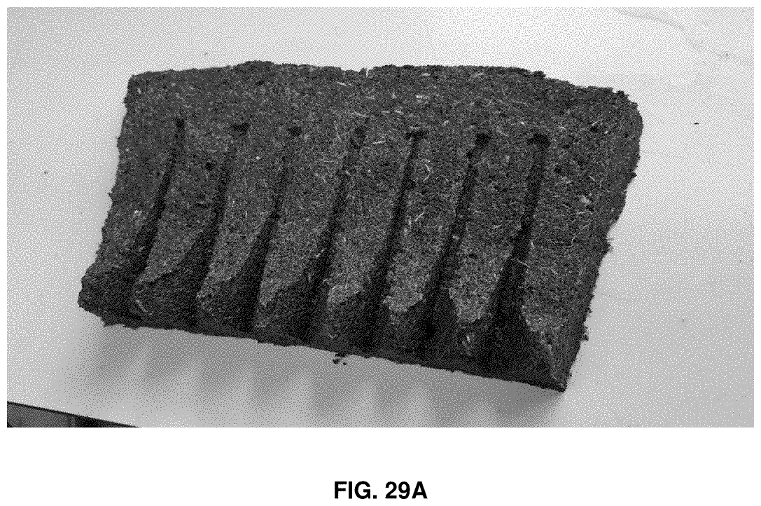

FIGS. 6-9 show photographs of example wraps having slits. FIG. 6 shows a photograph of several wraps with slits in a mold used to make the wraps. As seen in the photographs in FIGS. 6-7, the slits may be latitudinal slits that extend the entire width of the wrap. However, other configurations, shapes, and sizes of slits are entirely possible and encompassed within the present disclosure. For example, in an alternative embodiments, such as the embodiment depicted in FIG. 28 and described below, the slits may be latitudinal slits that do not extend the entire width of the wrap. FIG. 10 shows a photograph of an example mold that can be used to make a wrap having slits.

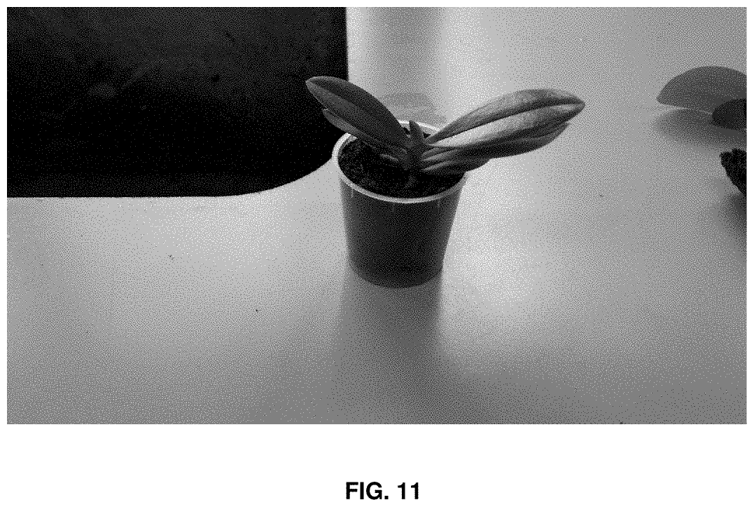

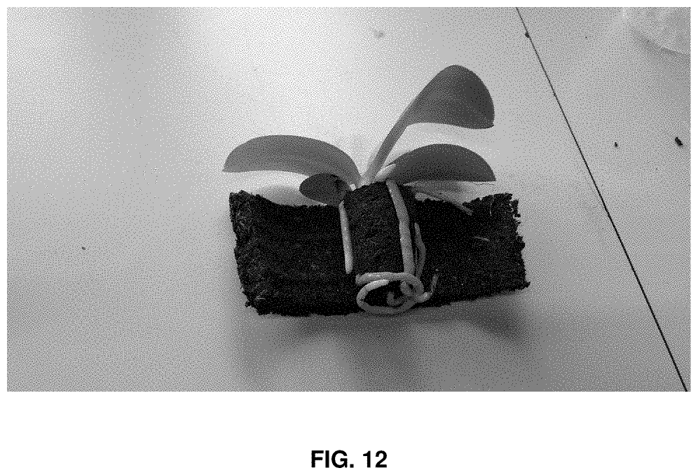

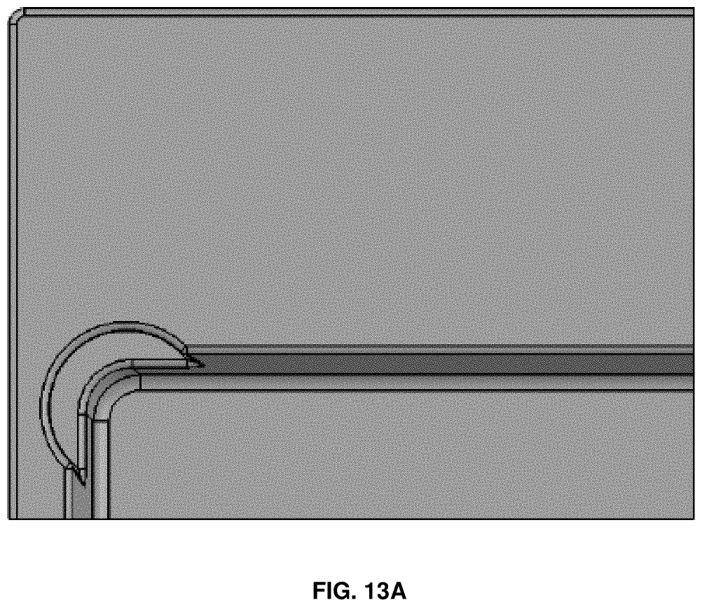

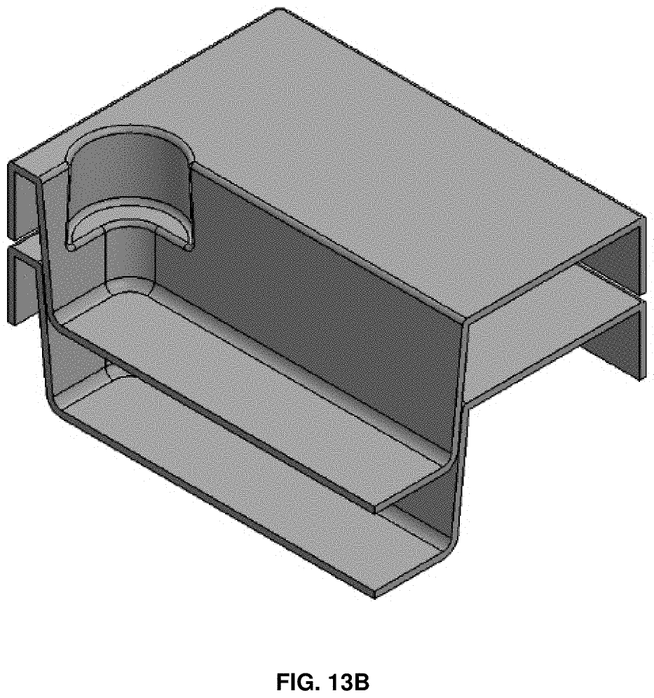

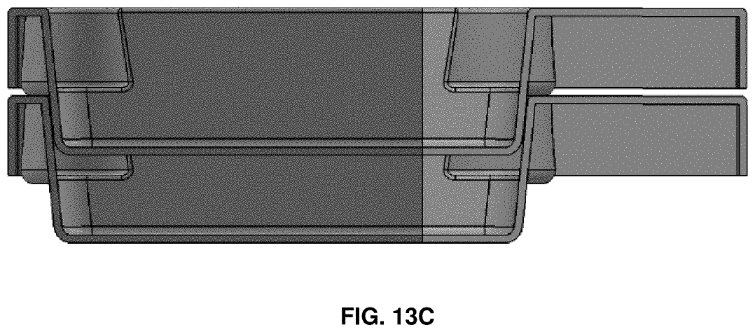

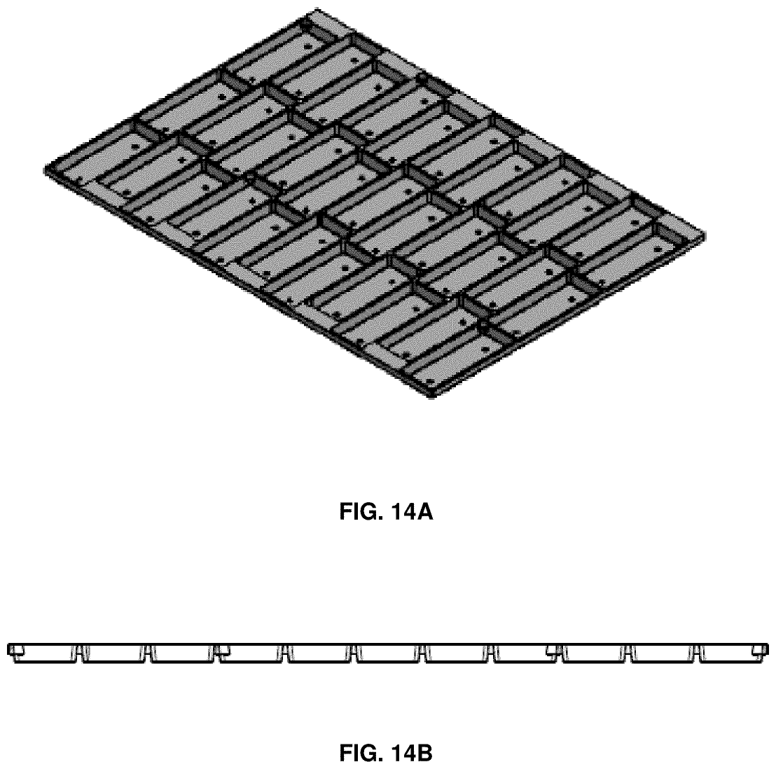

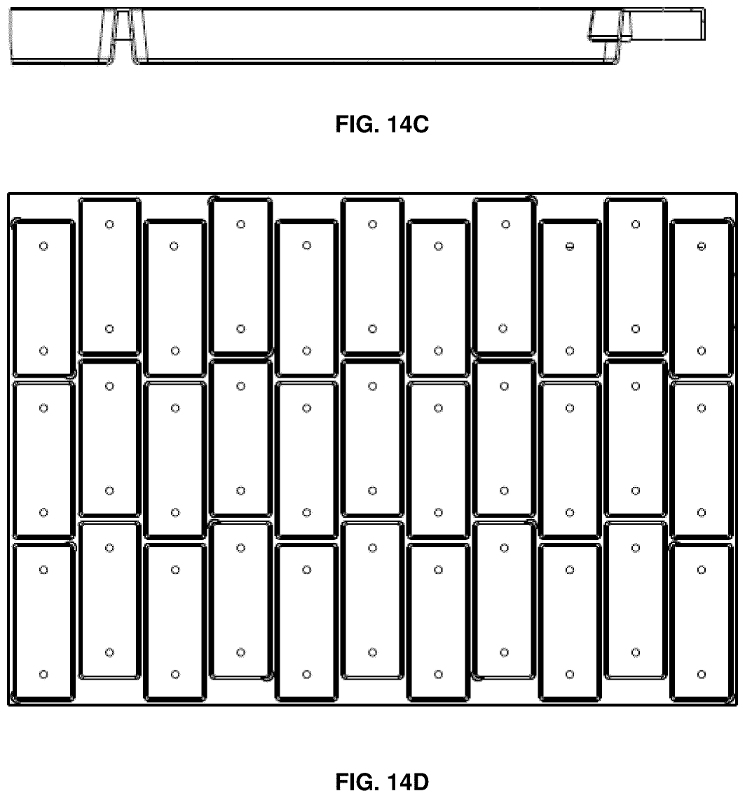

FIGS. 11-12 show photographs of a system with a wrap that substantially encircles a plug within a container, and FIGS. 13-14 show photographs and drawings of a mold that can be used to make the wrap.

The wrap 12 may be in the form of a single bendable piece of plant growth substrate mix, or may in the form of two or more pieces, or segments, of plant growth substrate mix which fit together to substantially encircle the plug 14. It has been found that simply planting a small plug into another larger plug with a hole that matches the smaller plug diameter does not always work very well because the roots may be broken or disturbed when forcing the transplant. Therefore, in some embodiments, the wrap 12 is cut into segments, such as in half to form two wrap segments, in order to allow a more gentle cupping around the roots 20, leaving the roots 20 undisturbed and intact. When the plant 18 reaches a size where it needs a larger container 16, the plant plug 14 can be transplanted in various substrates such as, but not limited to, bark, coir husk, or other coarse types of materials.

In some cases, plugs 14 may be too wet, which gives rise to fungal diseases like Rizoctonia. A close and dense growth environment is desirable to prevent pests such as the orchid worm from thriving, like it does in bark mixes. A wrap 12 having two half segments coming together to form a circle, optionally combined with a circular bottom, provides a system for situations where extra moisture is needed or desired. When present, the circular bottom may be made from the plant growth substrate mix of the wrap and/or plug, or may be another material, such as a fleece cloth or a coco fiber mat, and may optionally be included in the system 10 below the wrap 12 between the wrap 12 and the container 16.

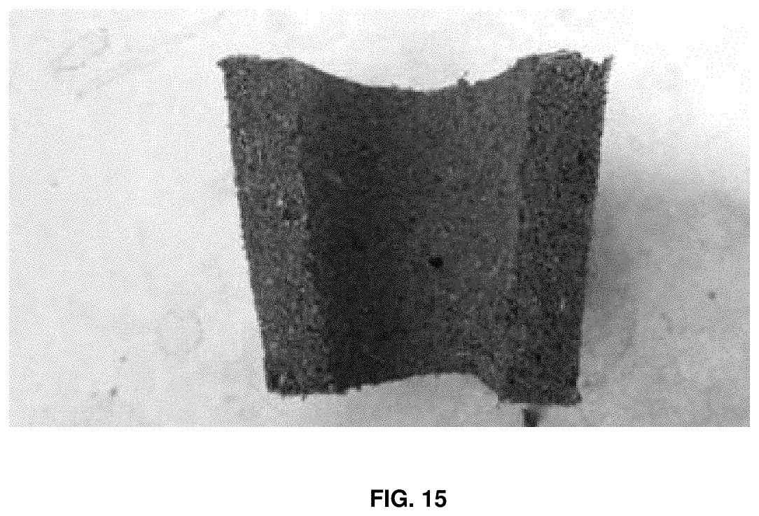

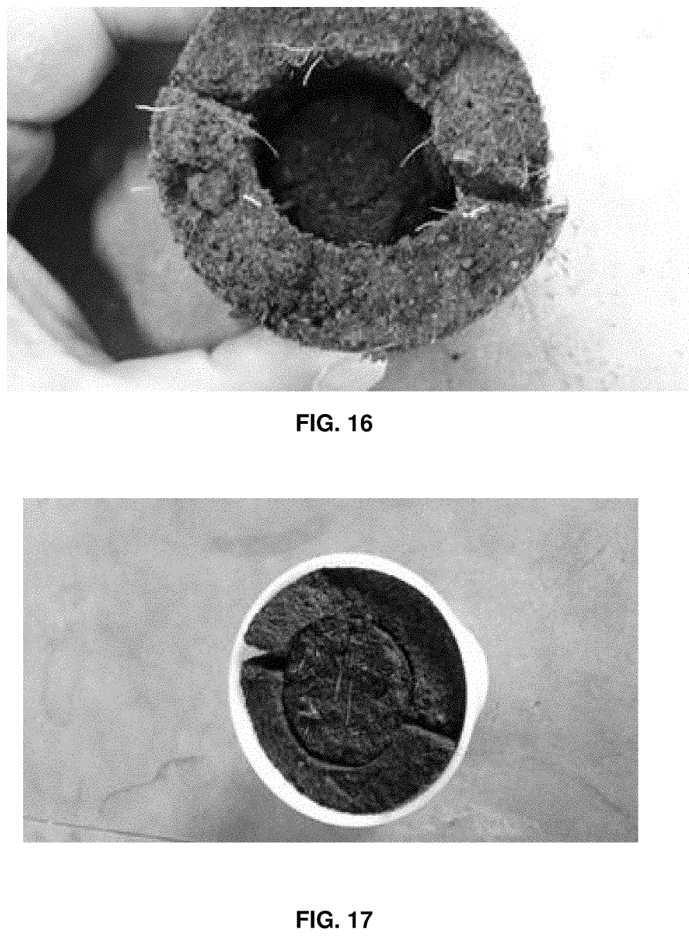

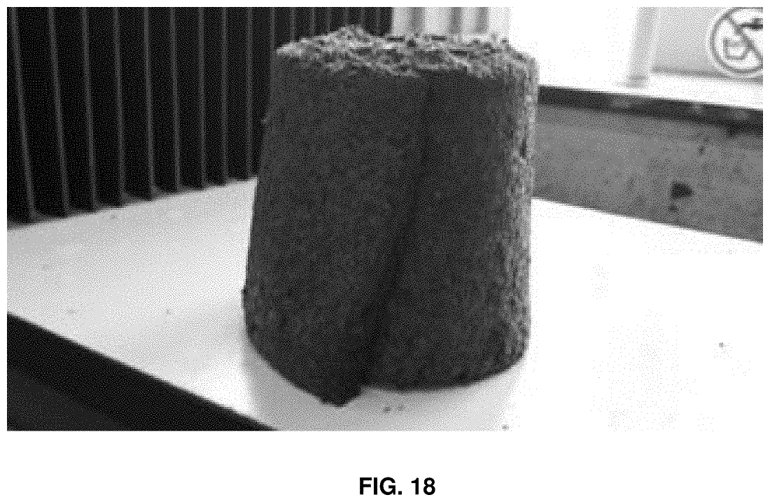

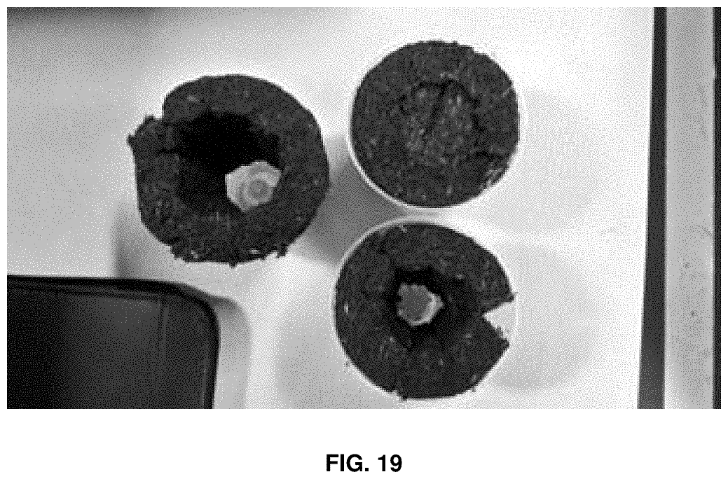

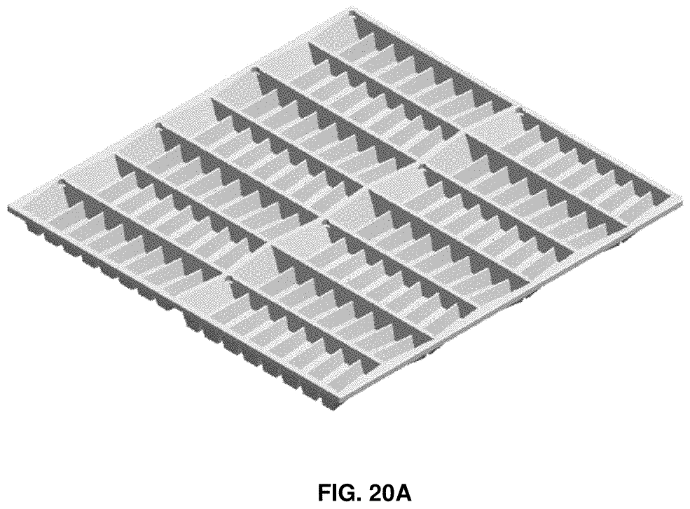

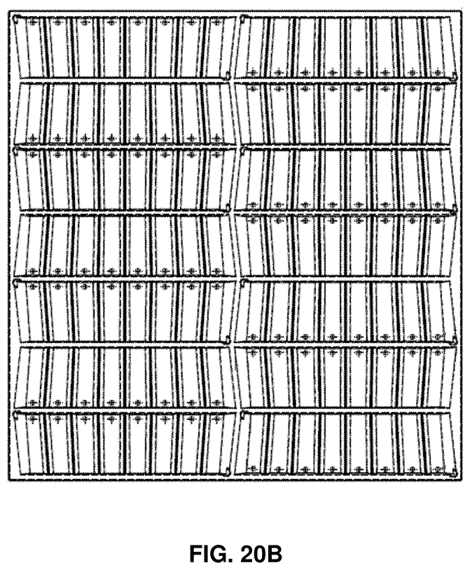

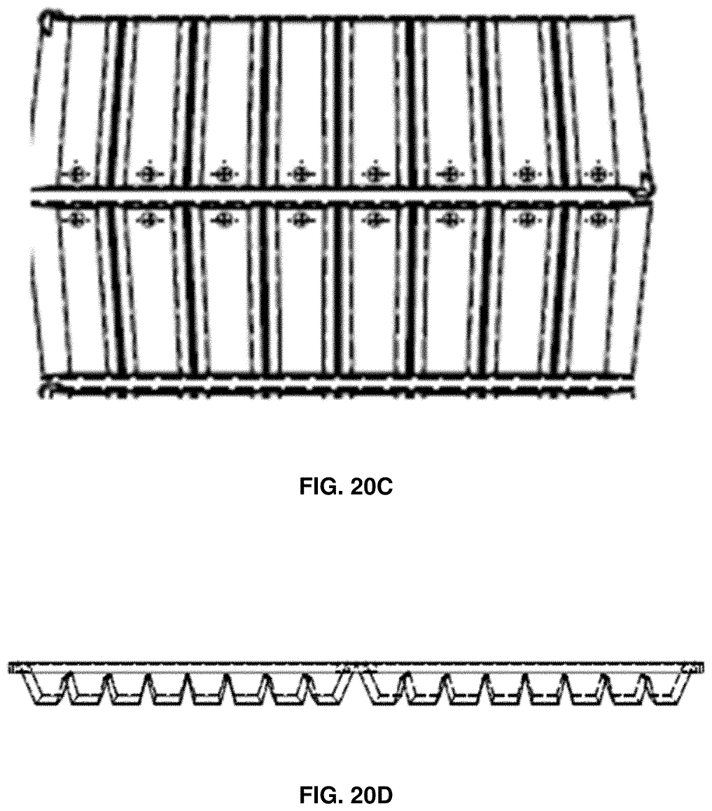

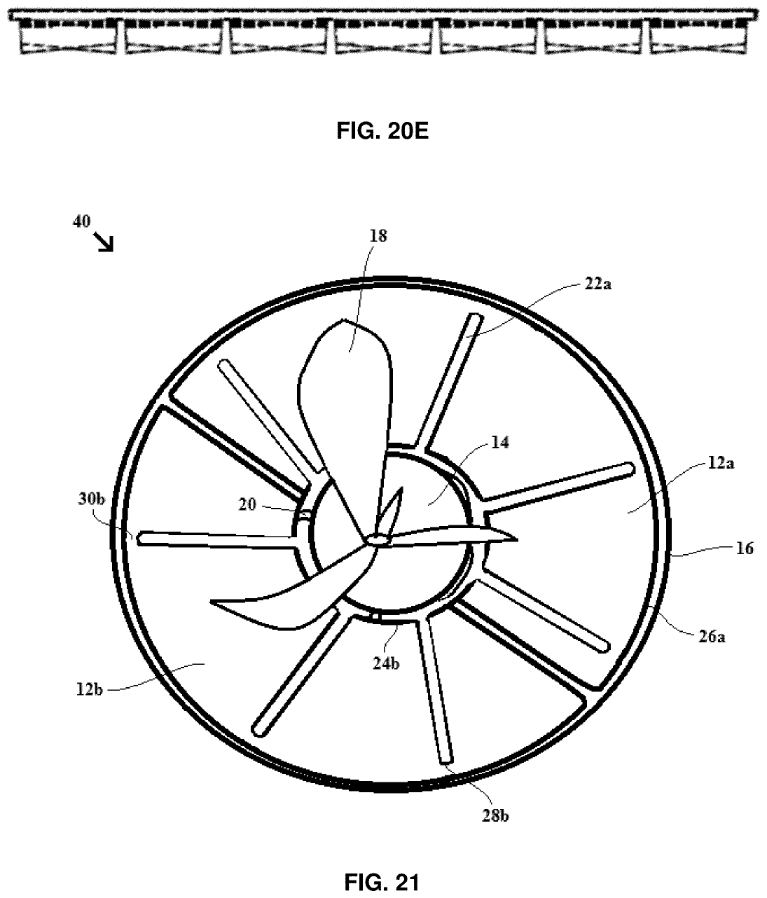

Referring again to FIGS. 4-5, the wrap 12 may have a first side 24 and a second side 26 that are both arcuate or subtly curved. This shape may generally provide for a good fit within the container 16. FIGS. 15-19 shows photographs of example half-moon shaped wraps. However, a half-moon shape is not necessary, and other shapes are possible. For example, in alternative embodiments, the wrap 12 may have straight or substantially straight sides, such as the first side 24 and second side 26. FIGS. 20A-20E show a side elevational view, two top views, and two side views of a tray mold that can be used to make wrap segments with slits and straight or slanted sides. In alternative embodiments, the wraps can be curved instead of straight.

Referring now to FIG. 21, a system 40 having a wrap 12 formed from a first wrap segment 12a and a second wrap segment 12b is depicted. Reference numbers in FIG. 21 in respect of features of the wrap segments 12a, 12b mirror those reference numbers in FIG. 2 in respect of features of the wrap 12, where the letter “a” denotes the feature is part of the first wrap segment 12a and the letter “b” denotes the feature is part of the second wrap segment 12b. As seen in FIG. 21, each of the first and second wrap segments 12a, 12b may be a semicircular or half-moon shape (from a top-down view) for ease of fitting together in the container 16. The first wrap segment 12a includes slits 22a, and the second wrap segment 12b includes slits 22b. However, it is possible, and entirely encompassed within the present disclosure, to have a system where one wrap segment 12a, 12b includes slits 22a, 22b and another wrap segment 12a, 12b does not include slits 22a, 22b. In other words, only one of the wrap segments 12a, 12b may include slits 22a, 22b. Furthermore, the wrap 12 need not be composed of just two wrap segments 12a, 12b; rather, it is understood that any number of wrap segments 12a, 12b may be used to form the wrap 12 in the system 40.

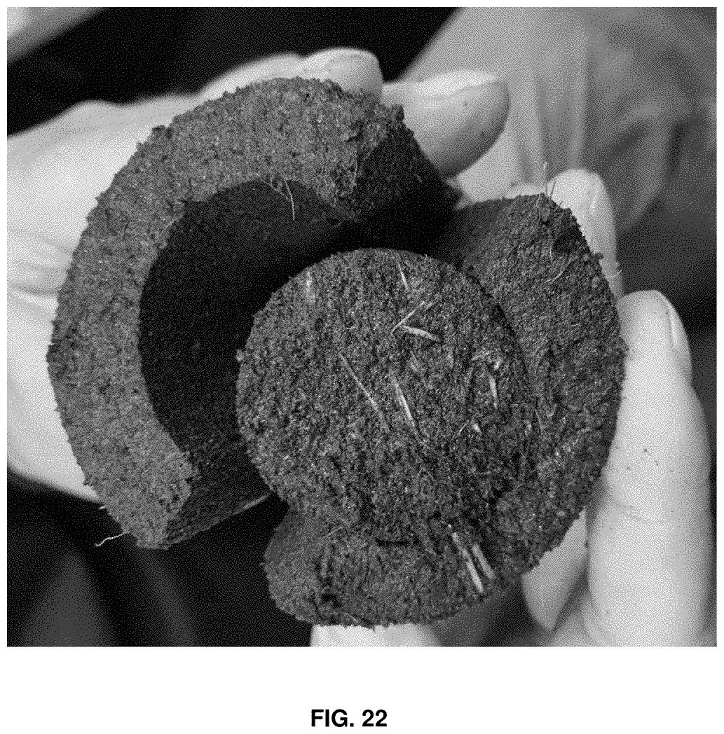

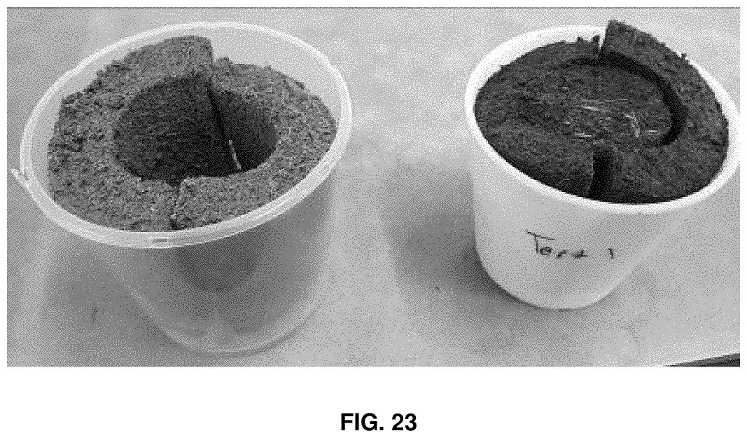

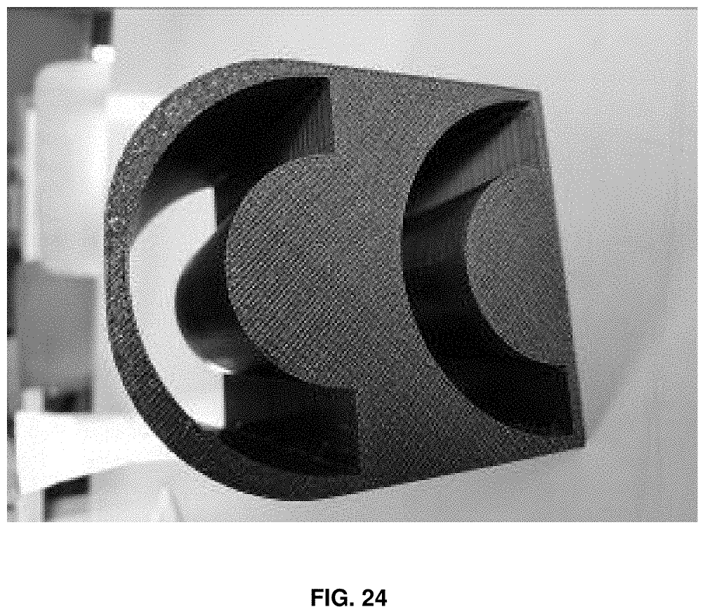

FIGS. 22-23 show photographs of a system having two semicircular wrap segments that fit together to substantially encircle a plug. As with any shape of wrap or wrap segment described herein, semicircular wrap segments may be made, for instance, using a 3D-printed mold, such as the mold depicted in FIG. 24. A plant growth substrate mix can be placed in the mold while wet, and heated or allowed to dry into the molded shape.

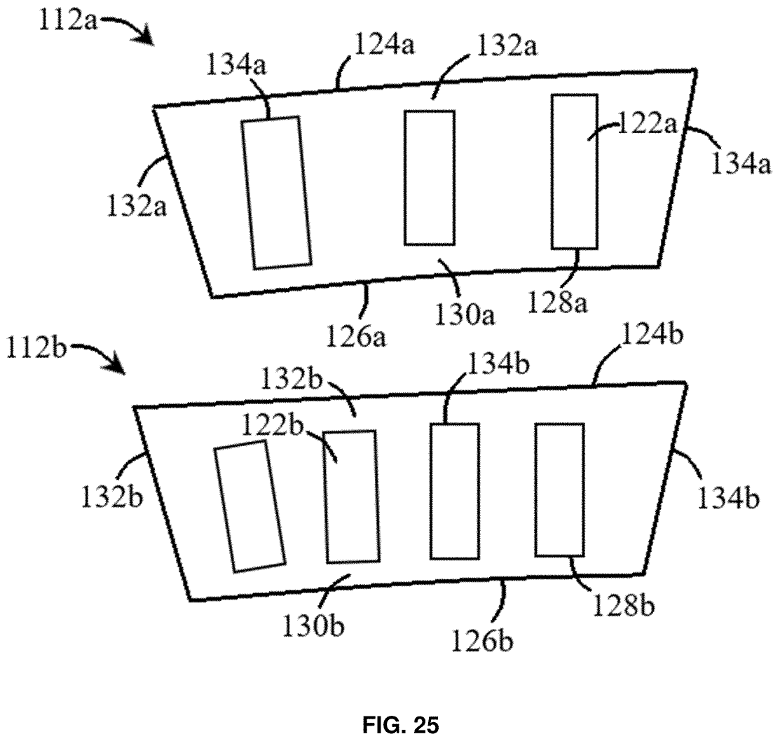

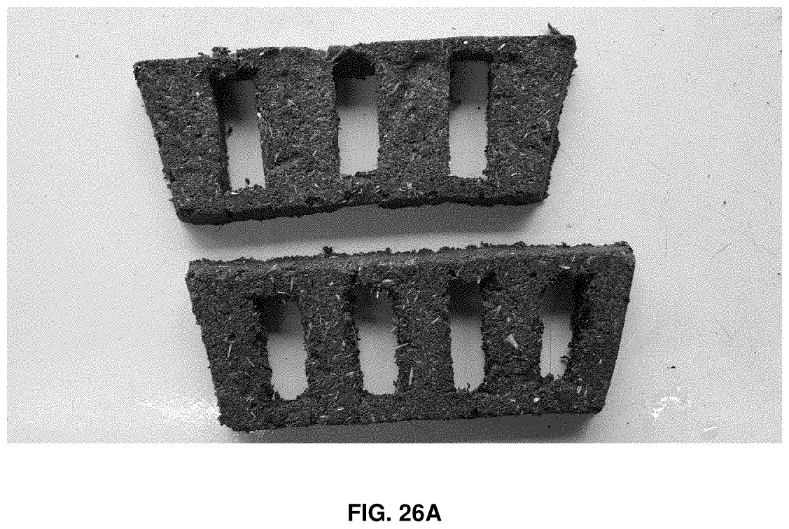

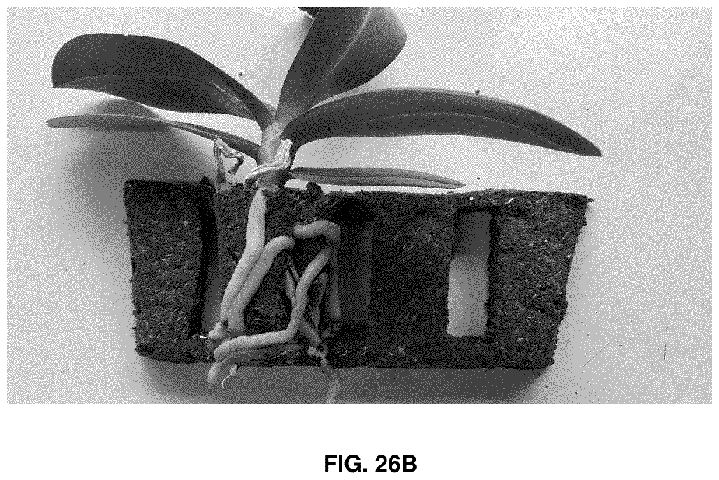

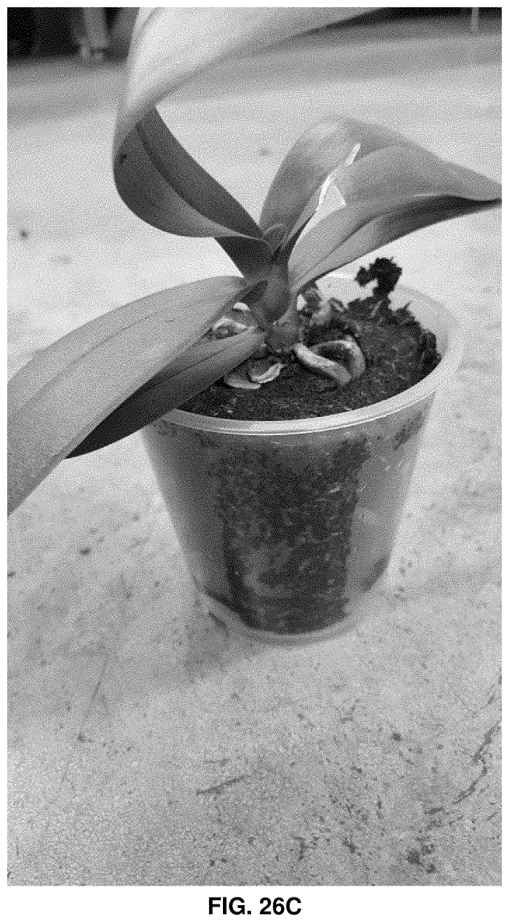

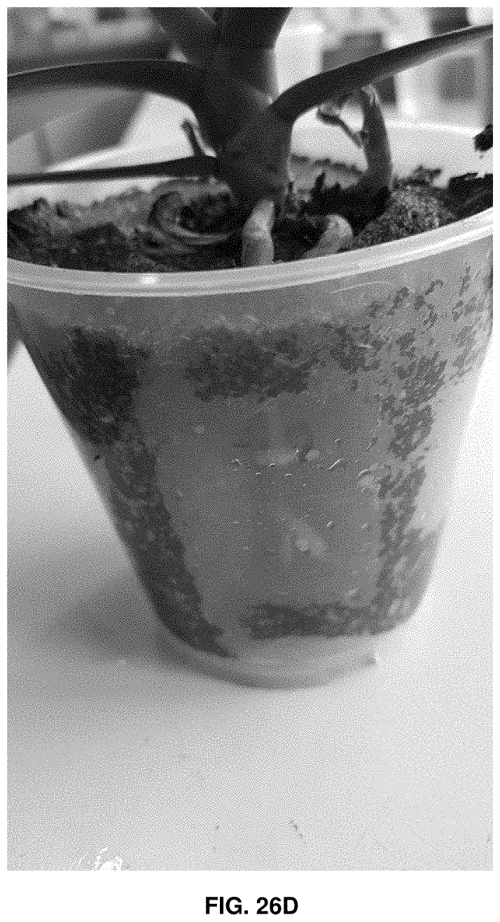

Referring now to FIG. 25, an alternative embodiment which includes wrap segments 112a, 112b is shown. As seen in FIG. 25, instead of slits 22, the wrap segments 112a, 112b may include air holes 122a, 122b which differ from the slits 22 in that they are not open at the first side 124a, 124b of the wrap segment 112a, 112b. Rather, the wrap segments 112a, 112b include air holes 122a, 122b that extend within the wrap segments 112a, 112b but not all the way to the first side 124a, 124b or the second side 126a, 126b. The air holes 122a, 122b are sized so as to ensure sufficient stability of the wrap segments 112a, 112b. Enough space remains in the areas 130a, 130b of the wrap segments 112a, 11b between the bottom 128a, 128b of each air hole 122a, 122b and the second side 126a, 126b, and in the area 132a, 132b between the top 134a, 134b of each air hole 122a, 122b and the first side 124a, 124b, to prevent the wrap segments 112a, 112b from falling apart when the wrap segment 112a, 112b is folded. As seen in FIG. 25, the number of air holes 122a, 122b may vary between the wrap segments 112a, 112b. Also, the dimensions of the air holes 122a, 122b may vary within each wrap segment 112a, 112b. A non-limiting example system exemplifying the embodiment depicted in FIG. 25 is shown in the photographs in FIGS. 26A-26D.

In other embodiments, a system may include one or more wrap segments that include a combination of slits 22 as depicted in FIGS. 1, 2, 4, 5 and air holes 122 as depicted in FIG. 25.

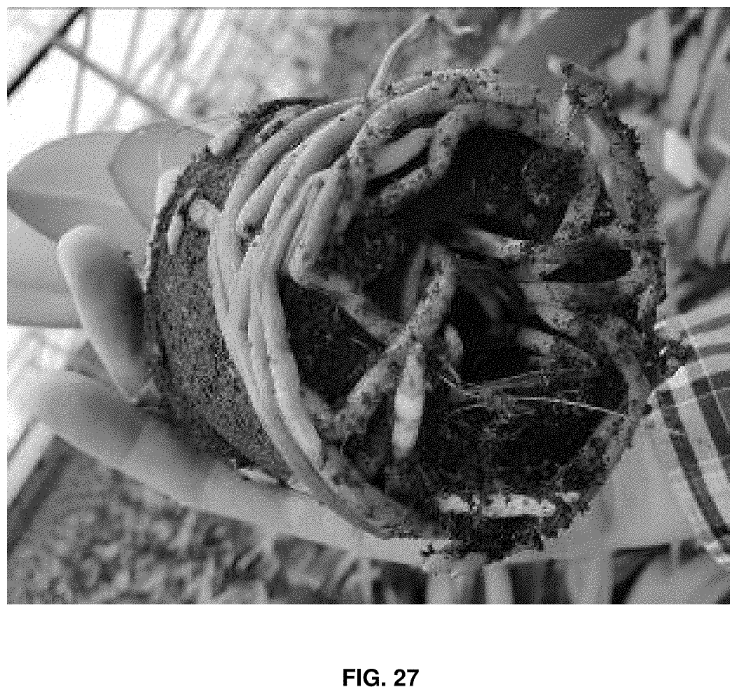

Regardless of the shape or features of the wrap or wrap segment, as seen in FIGS. 1, 2, 17, and 21, the wrap or wrap segment may substantially or completely encircle and cover the roots of the plant growing in the plug. This is especially advantageous when used to grow orchids, because orchids have large root structures, as seen in the photograph in FIG. 27. In this manner, the systems described herein also facilitate an easy transition into like-type material.

Furthermore, the systems described herein are advantageous because of their ability to hinder Lyprauta and Proceroplatus, which are two insects with larvae that create enormous damage to the roots of the Phalaenopsis and other species of orchids. These insects are common in orchids all over the world. The fly has to find big holes in the substrate to put an egg near the root system of the plant. The larvae eat the roots, creating damage to the plant. Since orchids are epiphytic plants that need a lot of air around the roots, these plants have historically been cultivated in open draining substrates, which provides a convenient location for the flies to place their eggs. However, the systems herein may stop these diseases completely. The substrate material of the wraps or wrap segments may comprise thousands of micro holes, which create the same physical character for the plant and its roots, but not for insects. In such embodiments, big holes are not present anymore, and the flies are therefore not able to enter the substrate to law down their eggs. Thus, the systems described herein provide a pesticide-free way of inhibiting these insects.

Also, the systems herein provide water and fertizilation efficiency. Since the wrap or wrap segments are semi-closed substrates that may comprise thousands of micro holes, water and fertilizer are buffered better and also for a longer period buffered in the substrate. In the past, watering has been done with a minimum 50% of drain, which means that to get 100 cc of fertilized water in a 12 cm pot, a grower would need to water a minimum of 150 cc. The overflow of 50 cc is generally washed out and, in many cases, lost to the environment. Thus, the systems herein significantly enhance the efficiency of watering and fertilizing.

Additionally, the growing speed of a plant may be improved with the systems described herein, due to the influence of the above-described inhibition of insects and enhanced watering/fertilizing efficiency. A growth speed improvement of about 20% may be realized with the systems described herein. For example, where production time is normally 52 weeks, this means a shorter growing time of 42 weeks. And, since orchids are grown in heated greenhouses all around the world, this inherently reduces the use of energy.

Though orchids are often mentioned herein for illustrative purposes, the plant 18 need not be an orchid. In fact, the system 10, 40 may be changed in various ways to adapt to the particular needs of other types of plants 18. For example, FIG. 28 depicts an embodiment of a wrap 212 that is especially advantageous for use with lilies, though can be used with any type of plant. Referring now to FIG. 28, a wrap 212 may include incisions 222. The incisions 222 may be graded (i.e., sloping) areas of cutaway material in the wrap 212, or may have a uniform depth. However, the depth of each incision 222 is less than the thickness t of the wrap 212, which is the distance between the top surface 242 and the bottom surface 244 of the wrap 212. In other words, the incisions 222 are not all the way through the material of the wrap 212. Each incision 222 may extend from a position 236 within the wrap 212 spaced apart from the first side 224 to the second side 226 of the wrap 212. The number of incisions 222 from the first end 232 to the second end 234 may vary and is not particularly limited. The position 236 may vary for each incision 222, or may be substantially the same for each incision 222. The space s between each incision 222 may also vary or be substantially the same across the wrap 212. As with other embodiments described herein, the incisions 222 may be sized so as to ensure that the area 230 between the first side 224 and each incision 222 is large enough to prevent the wrap 212 from falling apart when the wrap 212 is folded to fit in a container.

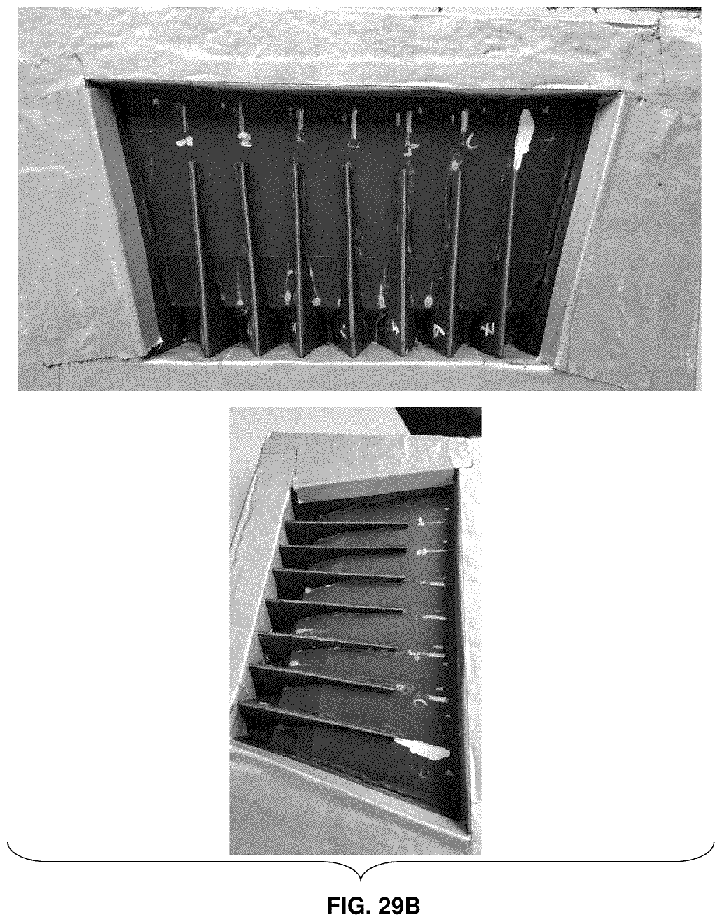

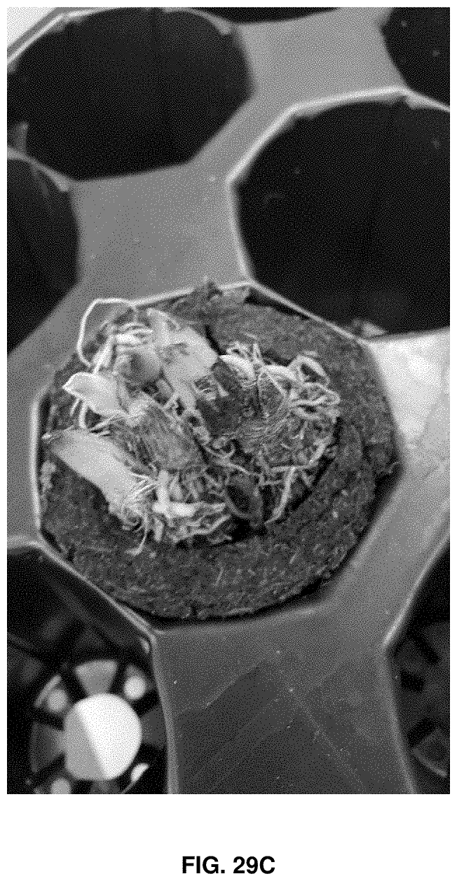

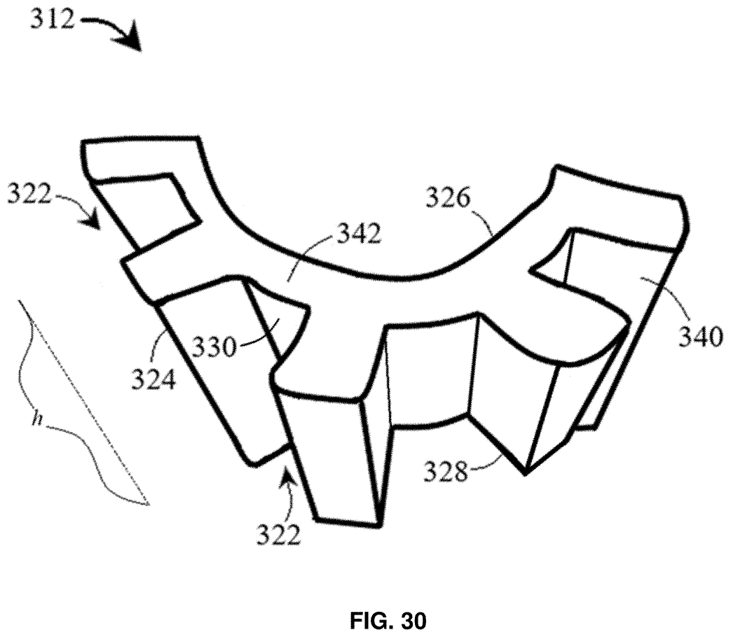

The wrap 212 shown in FIG. 28 is ideal for lilies, which may have roots that vary in shape, because it provides an optimal fit, filling the space available between the plug and the container as much as possible with the material of the wrap and plug. The wrap 212 may be wrapped around a plug containing 3 rooted plants instead of a plug containing a single plant. The wrap 212 may have a curved shape, and the incisions 222 may form a round pocket when wrapped around the roots of the rooted plants so as to hold the roots with the best fit while having the least amount of air in the container possible. In some embodiments, the wrap 212 is sized such that there is substantially no air in the container. The wrap 212 with the rooted plants can then be placed in a tray cavity, pot, or other container. FIG. 29A shows a photograph of an example wrap as depicted in FIG. 28. FIG. 29C shows a photograph of a wrap as depicted in FIG. 28 holding 3 rooted lilies within a cavity in a tray. Such a wrap may be made using a mold as shown in FIG. 29B, which has a curved bottom for giving the wrap its curved shape and teeth for creating the incisions. As seen in FIG. 29B, the teeth are graded slopes in order to form the incisions as graded areas of omitted material.

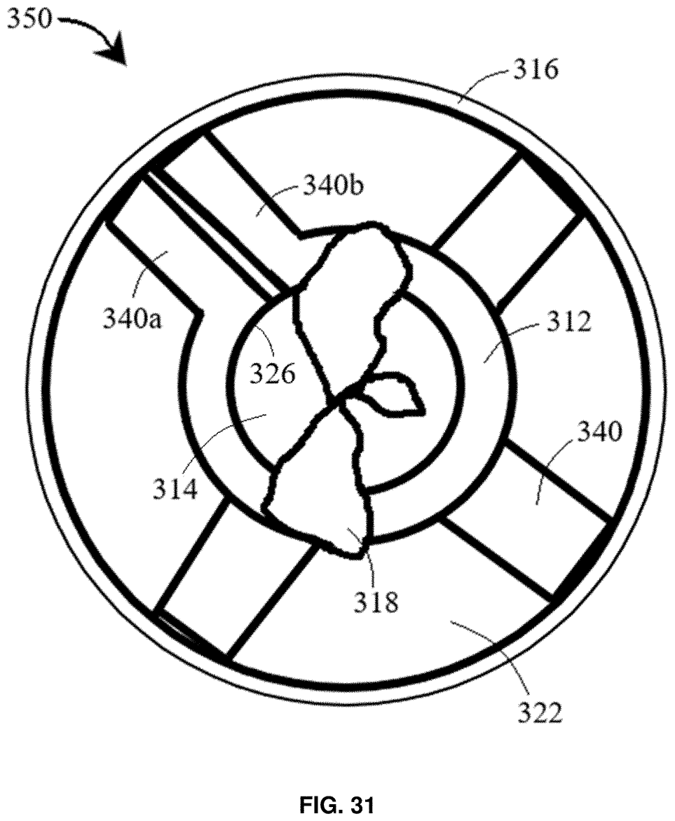

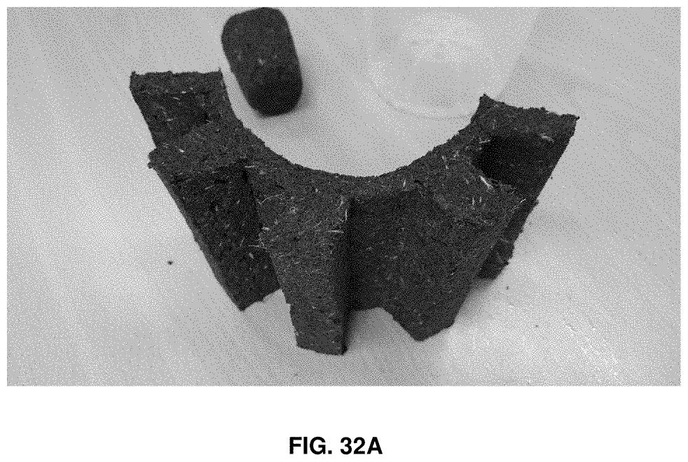

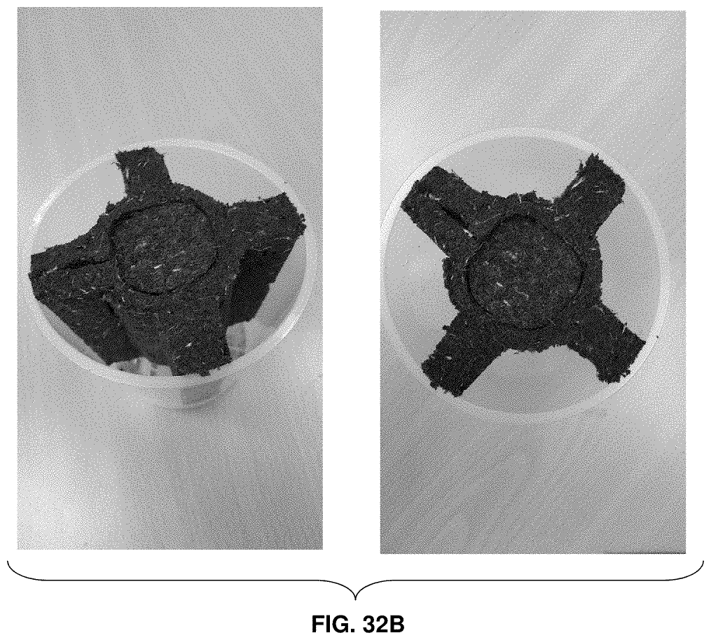

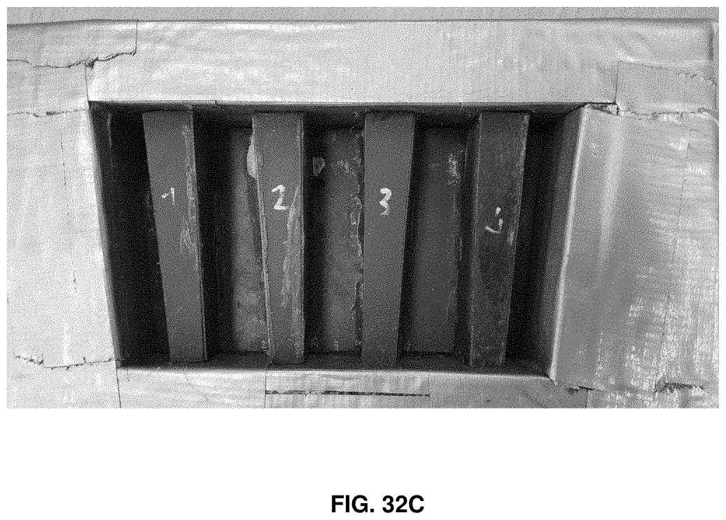

Typically, wraps are used to fill up the space between the plug and container as completely as possible. However, in some embodiments, a wrap may be used to provide a lot of air to improve root growth and development, while still holding the plug stable within the container. This may be advantageous for certain types of plants. Referring now to FIG. 30, an alternative embodiment of a wrap 312 is depicted. A wrap 312 may be formed with slits 322 large enough to effectively form rectangular protrusions 340 of the wrap material (i.e., the plant growth substrate mix that the wrap 312 is formed from) between the slits 322. In other words, the slits 322 separate rectangular protrusions 340. The protrusions 340 extend from the second side 326 to a tip defining the first side 324 of the wrap 312, and extend along the height h of the wrap 312 from the bottom surface 328 to the top surface 342. The area 330 of the wrap 312 between protrusions 340 is a sufficient size to prevent the wrap 312 from falling apart. The number of protrusions 340 may vary and is not particularly limited. Furthermore, each protrusion 340, and the spacing between each protrusion 340, may vary in size. In this embodiment, the wrap 312 does not fill up substantially all of the space between the plug and the container, and thereby instead provides additional air to improve the root growth and development of the plant. Furthermore, as depicted in FIG. 31, a system 350 with this embodiment of the wrap 312 may be inserted into a container 316 in the opposite manner as previously described, namely, with the slits 322 facing the container 316 as opposed to facing the plug 314 having the plant 318 growing therein. In this manner, the second side 326 of the wrap 312 is in direct contact with the plug 314 and/or roots of the plant 318. As also seen in FIG. 31, a single wrap 312 may be used with the end protrusions 340a, 340b meeting each other when the wrap 312 is folded around the plug 314 within the container 316. For this reason, in some embodiments, the end protrusions 340a, 340b are each smaller than the other protrusions 340. Furthermore, in some embodiments, the end protrusions 340a, 340b have slanted or angled edges so as to form a better fit together. FIGS. 32A-32B show photographs of this embodiment, with a wrap surrounding a plug in a container. FIG. 32C shows a mold which may be used to form such a wrap.

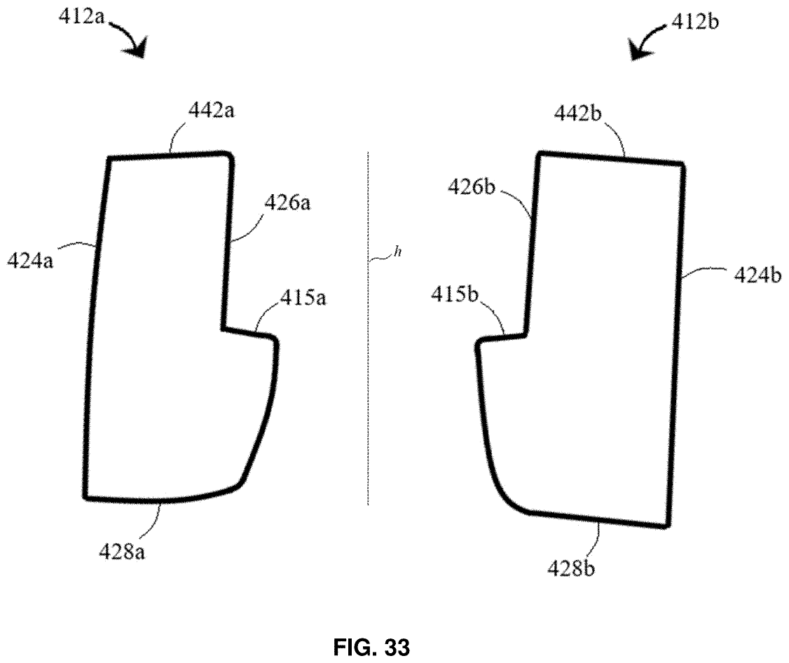

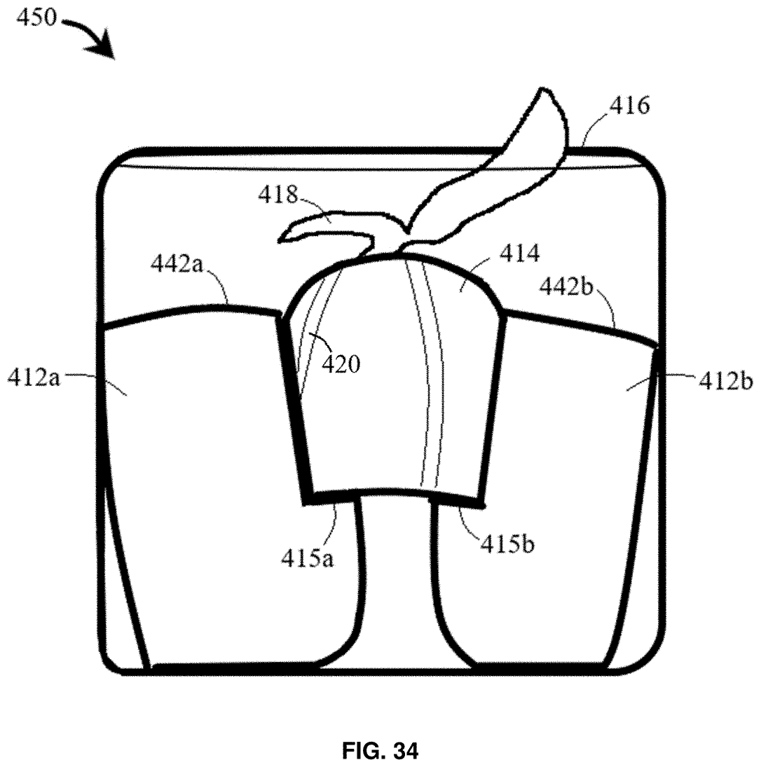

Referring now to FIG. 33, an alternative embodiment of a wrap 412 is shown. In this embodiment, the wrap 412 is formed from a plurality of wrap segments 412a, 412b where one or more of the wrap segments 412a, 412b has a ledge 415a, 415b on which a plug may rest. The ledge 415a, 415b is configured to support the plug. As seen in FIG. 33, from a side view, the wrap segments 412a, 412b may have an L-shape because of the ledges 415a, 415. The ledge 415a, 415b may be on the second side 426a, 426b of the wrap segment 412a, 412b. The first side 424a, 424b of the wrap segment 412a, 412b may remain substantially flat, and may be configured to be in direct contact with the walls of the container. In other embodiments, the first side 424a, 424b may be arcuate or curved. The ledge 415a, 415b may be about halfway between the bottom surface 428a, 428b and the top surface 442a, 442b (i.e., about halfway along the height h of the wrap segment 412a, 412b), but need not be. Other locations for the ledge 415a, 415b along the height h of the wrap segments 412a, 412b are entirely possible and encompassed within the scope of the present disclosure. Optionally, an absorptive ring may be inserted around the wrap 412 when inside a container in order to absorb or hold more water within the system. The wrap 412 provides a significant amount of air for root growth and development. In this manner, the wrap 412 depicted in FIG. 33 is similar to the wrap 314 shown in FIGS. 30, 31, and 33, except that the area 330 of the wrap 312 has been eliminated.

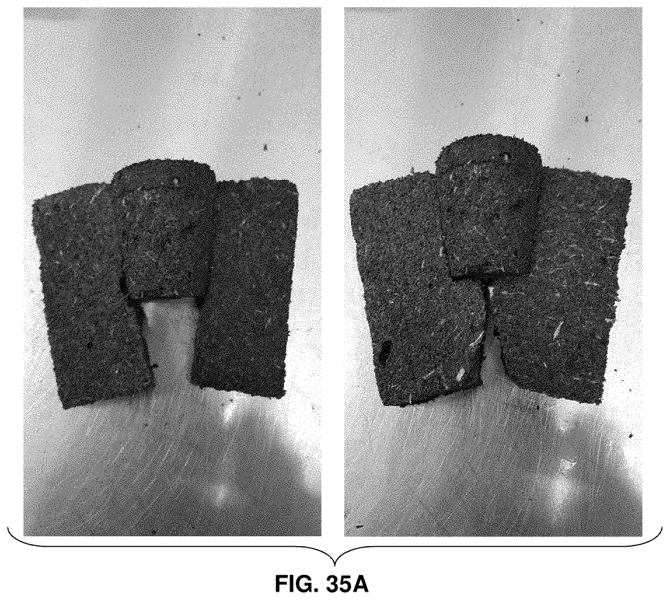

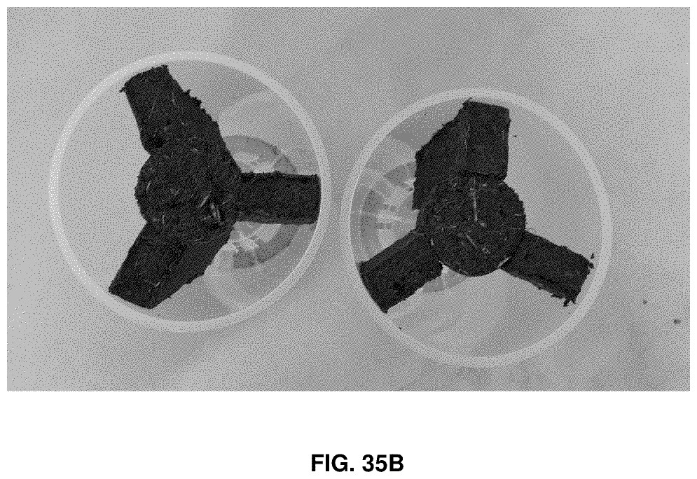

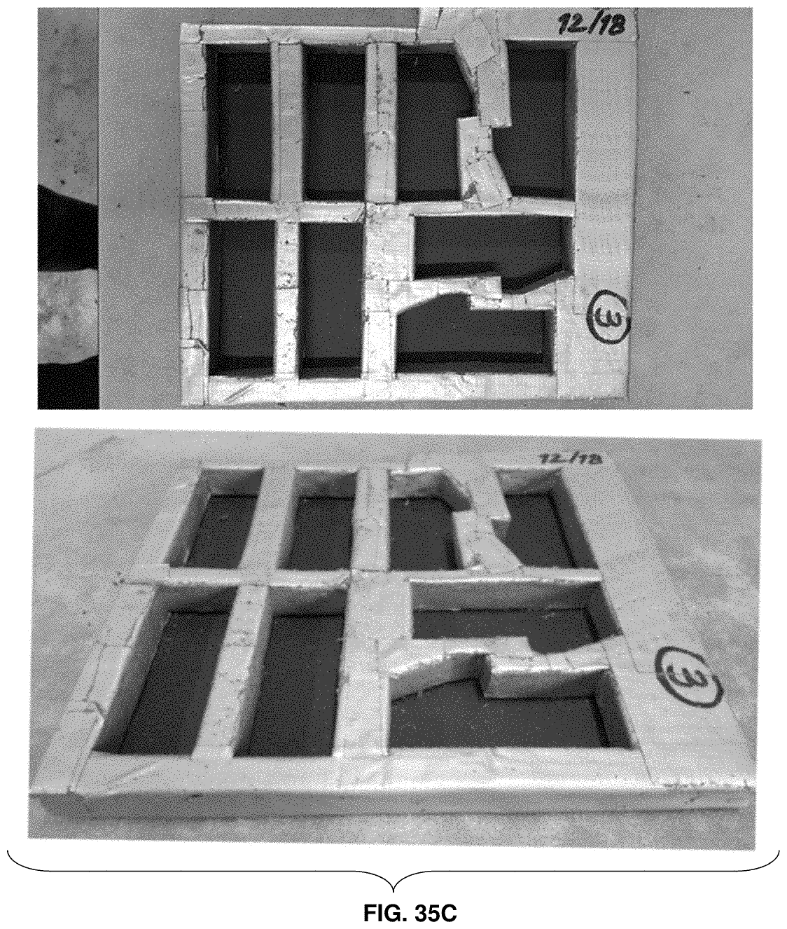

FIG. 34 depicts a side view of a system 450 with a wrap 412 as depicted in FIG. 33, where the wrap 412 is surrounding a plug 414 with a plant 418 growing therein. The plug 414 rests on each of the ledges 415a, 415b of the wrap segments 412a, 412b. The plug 414 may extend above the top surfaces 442a, 442b of the wrap segments 412a, 412b. Optionally, the wrap segments 412a, 412b may further include slits or incisions to better accommodate the roots 420 of the plant 418. FIG. 35A shows photographs of such wrap segments with a plug resting on ledges, FIG. 35B shows a photograph of an example system utilizing wrap segments with ledges, and FIG. 35C shows a photograph of a mold that can be used to make wrap segments with ledges. As seen from the mold in FIG. 35C, wrap segments with ledges may be combined in a system with wrap segments without ledges. The number of ledges included in a system for plant propagation is not particularly limited.

As noted above, the wrap and the plug of any system described herein may each be composed of a plant growth substrate mix. Thus, in some embodiments, the plug comprises a first plant growth substrate mix, and the wrap comprises a a second plant growth substrate mix. In some embodiments, the plug and the wrap are composed of identical plant growth substrate mixes. In some embodiments, the plug and the wrap are composed of two plant growth substrate mixes that have about 50% identity with each other. In embodiments wherein the wrap is composed of multiple wrap segments, each wrap segment may include the same plant growth substrate mix, or may include different plant growth substrate mixes, which may or may not be the same as the plant growth substrate mix of the plug.

Though the material of the plug and the wrap need not be identical, numerous advantages are realized by having the plug and the wrap be composed of the same material, and thereby having a matching cultural fit. For example, there may be no transplant shock because of the environmental similarities. New root growth is generally seen within about one week. There is better shelf life for the plant. The plant growing in the plug will not dry out as easily, and watering frequency can be extended, such as from 4 days to 8 days for an orchid. Also, for an orchid in particular, there is a reduction of potential root loss during the 10 week cooling period and 15 week flowering period. Furthermore, material handling is improved. There is easy flexibility when transplanting into various sized containers. Also, the pushing force of the root out of the container is inhibited. All of these advantages may be realized by having the plug and the wrap (or wrap segments) be composed of the same plant growth substrate mix. In any event, in some embodiments, the wrap and the plug are composed of different plant growth substrate mixes.

Any suitable plant growth substrate mix may be used to form the wrap, wrap segments, or plug. By way of non-limiting example, a plant growth substrate mix may include peat, coir, pine or other barks, perlite, compost, fertilizers, minerals such as vermiculite, manure, granulated lava, pumice, burnt or calcined clay, mineral fibers, Sphagnum moss, Hypnaceous moss, rice hulls, bagasse, sand, perlite, leaf mold, gypsum, limestone, clay, wood fibers, cellulose fibers, lignocellulose fibers, hemp fibers, synthetic fibers, coir fibers, or combinations thereof. Non-limiting examples of suitable commercially available substrate mixes include Jiffy Seedling Mix 17-1 (composed of white peat, perlite, and vermiculite), Jiffy 7 QSM (quick soil mix without netting), Jiffy Blend #3 (comprising coir and peat), Jiffy Blend #10 (70% coir, 26% sphagnum peat, 4% perlite), Jiffy Seedling Mix 17-3 (70% peat, 20% perlite, 10% vermiculite), Jiffy Blend #30 (70% Canadian sphagnum peat, 20% coir, and 10% perlite), and Preforma® mixes.

The plant growth substrate mix of the wrap, wrap segments, or plug may also include various additives such as, but not limited to, polyurethane, polyvinyl alcohol (PVA), polyvinyl acetate (PVAC), or clay; crosslinkers such as tripolyphosphate, citric acid, glyoxal, dimethylol dihydroxy ethylene urea (DMDHEU), aldehydes, thermo setting resins, salts of multi-variant anions, isocyanate, poly(acrylic acid), bis(hyudroxyethyl) sulfone (BHES), glutaraldehyde, succinic acid, butane tetracarboxylic acid, alumina, epichlorohydrin, borax, aluminum hydroxide, hydrated aluminum chloride, aluminum acetate, aluminum sulfate, glycine, malic acid, tartaric acid, oxalic acid, dialdehydes, polyaldehydes, epoxides, triphosphates, divinyl sulphone, thiol reagents, and C2 to C9 polycarboxylic acids; accelerators such as sodium hypophosphite; additional binders; plasticizers, such as glycerol, phthalate esters, ethylene glycol, diethylene glycol, polyethylene glycols, propylene glycols, polypropylene glycols, 1,3-butylene glycol, 1,3-propanediol, urea, trimethylamine hydrochloride, pentanediol, block copolymers of polyoxypropylene, hexitols, and oxyalkylene derivatives of hexitols; pH buffers; expanded polystyrene; urea formaldehydes; and microelements (e.g., iron, manganese, zinc, copper, boron, molybdenum, chloride, and nickel). Various additives and binders are described in the international application PCT/US18/15250, which is incorporated herein by reference in its entirety.

One non-limiting example of a type of suitable plant growth substrate mix is commercially available under the name Preforma®. In some embodiments, the system described herein includes a plug comprising Preforma® and/or a wrap or wrap segment comprising Preforma®. Preforma® mixes are described in U.S. Pat. No. 6,322,734, which is incorporated herein by reference in its entirety. In general, Preforma® mixes are hydrophilic growing media that form resilient, integral, dimensionally stable, cohesive, homogeneous masses by contacting an aggregate with a hydrophilic urethane prepolymer and water.

Preforma® plugs, wraps, or wrap segments may be made by forming a slurry composed of aggregate, hydrophilic polyurethane prepolymer, and water, mixing the slurry at a temperature below 20° C. to create a homogeneous mixture, pouring the mixture into a mold, and allowing the mixture to cure in the mold to create a plug or wrap of the desired size and shape. The aggregate in Preforma® is one of peat, soil, coir, perlite, vermiculite, pumice, baked clay, wood pulp, wood fiber, coir fiber, hemp fiber, synthetic fiber, ground tree bark, sawdust, or mixtures thereof. The binding agent in a Preforma® mix is a hydrophilic polyurethane prepolymer, such as those that are the reaction product of a polyol, preferably a polyoxyethylene polyol, with a polyisocyanate. Example prepolymers include those described in U.S. Pat. No. 3,812,619, which is incorporated herein by reference. The ratio of prepolymer to aggregate can be about 0.02-0.14:1, and the amount of water added is generally about 1-16 kg/5 kg aggregate. Example Preforma® formulations are disclosed in U.S. Pat. No. 6,322,734, which is incorporated herein by reference in its entirety.

Regardless of the exact composition of the wrap or wrap segments, the wrap or wrap segments are generally made of a soft, flexible material. Softness and flexibility are important for achieving ideal root development. The wrap or wrap segments may encircle or substantially encircle the plug and fill the void around the final container diameter. In some embodiments, the wrap or wrap segments are composed of a plant growth substrate mix that includes polyurethane, which provides flexibility to the wrap or wrap segments, allowing the wrap or wrap segments to be bendable enough to wrap around the plug within the container. The wrap or wrap segments should be stable and bendable into the container. Optimally, the wrap or wrap segments should not leave a significant volume in the container which is unfilled with plant growth substrate mix. Having empty spaces in the container, such as seen in FIG. 19, is often undesirable. However, this is not strictly necessary, and systems having empty spaces in the container, such as the system 350 depicted in FIG. 31, are nonetheless encompassed within the scope of the present disclosure.

As one non-limiting example, the wrap, or wrap segments, can be cut out of a carpet of plant growth substrate mix. A carpet of plant growth substrate mix can be formed by pouring a slurry, such as a Preforma® slurry, in a rectangular shaped form or other mold, such as a mold having dimensions of 1×3 meters×10-40 mm, so that a carpet of, e.g., 10-40 mm, is formed. After solidifying, the shapes can be cut out from the carpet form to get a special designed fit to the different containers. This method may also save on waste. It is important to retain the flexibility of the carpet so that the wrap or wrap segment is bendable without breaking up, in order for it to be placed into a pot. Robotic equipment may be utilized to streamline the manufacturing process.

By making the wrap or wrap segment in a flat form, it is also possible to add in solid fiber components, such as wood fiber or coir fiber, into the middle of the carpet, in order to save on the amount of binder. This has a cost advantage.

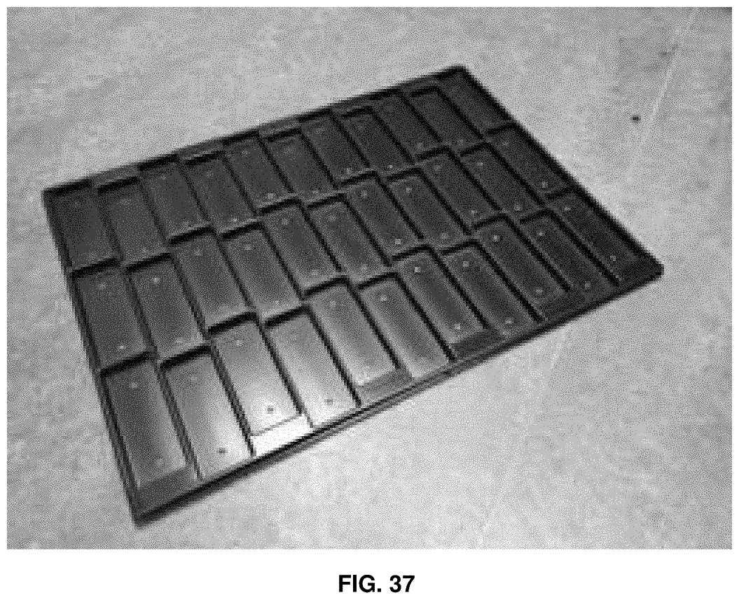

As another example method for making the wrap or wrap segments, a plant growth substrate mix can be combined with water to to make a slurry, and a mold, such as the example molds depicted in FIGS. 13-14, is filled with the slurry. Then, the slurry is allowed to dry into a firm plant growth substrate mix in the shape of the mold. FIGS. 24, 36, 10, 29B, 32C, 35C, and 20A-20E show other non-limiting example molds for creating a wrap or wrap segments as described herein. The mold in FIG. 37 can be used to create rectangular shaped wraps which serve as single-piece wraps or half-wrap segments inside a container. The mold shown in FIG. 24 can be used to create semicircular or half-moon shaped wraps or wrap segments without slits. The terms semicircular and half-moon shaped are used in reference to a top-down view of the wraps or wrap segments. The mold shown in FIG. 10 can be used to create curved or arcuate wraps or wrap segments with slits. As seen in FIG. 10, the mold is curved. The wraps or wrap segments produced from the mold in FIG. 10 have an arcuate first side and an arcuate second side. It has been found that curved wrap segments may create a better fit within a container than rectangular wraps (again in reference to a side view of the wraps or wrap segments). For example, as seen in FIG. 19, rectangular shaped wraps can leave a triangular shaped void in the container, whereas curved wraps or wrap segments are better suited to leave no significant voids within the container. The mold shown in FIG. 29B can be used to make wraps or wrap segments having incisions and straight first and second sides. The mold shown in FIG. 32C can be used to make wrap segments having large slits so as to form rectangular protrusions of plant growth substrate mix. The mold shown in FIG. 35C can be used to make wraps or wrap segments with ledges. The mold shown in FIGS. 20A-20E can be used to make wraps or wrap segments with slits and having straight or slanted first and second sides.

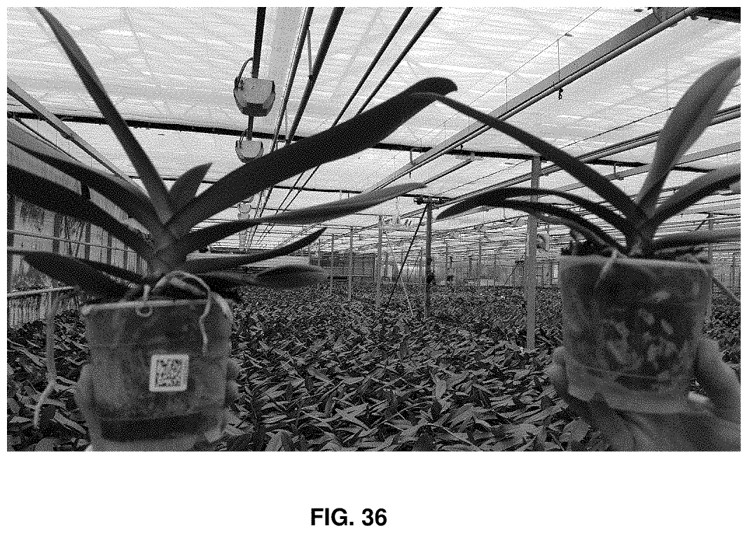

A wide variety of plugs can be utilized in the systems and methods described herein. Plugs are typically in the form of a dimensionally stable body of growing medium having one or more holes in the upper surface into which a seed or an un-rooted cutting, or a pre-rooted cutting, can be inserted. Plugs may be, for instance, block-shaped or cylindrical, and may be of any size suitable for plant growth. Plugs designed for orchid growth may generally be larger than plugs designed for the growth of other plants. For example, jumbo plugs designed for orchids can be seen in the photographs if FIGS. 27, 36. Any plug composed of a plant growth substrate mix can be used in the systems and methods described herein. Non-limiting example plugs are described in international application PCT/US18/15250, which is incorporated herein by reference in its entirety. Other non-limiting example plugs are described in U.S. Pat. No. 6,322,734, U.S. Pat. No. 3,805,531, and U.S. Pat. No. 4,175,355, each of which is incorporated herein by reference in its entirety. Plugs may be manufactured by, for example, mixing plant growth substrate materials together and forming a mixture having a desired shape, adding water to activate binding within the mixture, and allowing the mixture to dry in the desired shape. However, any suitable method may be used to manufacture the plugs for the system described herein. Alternatively, the plugs may be purchased commercially.

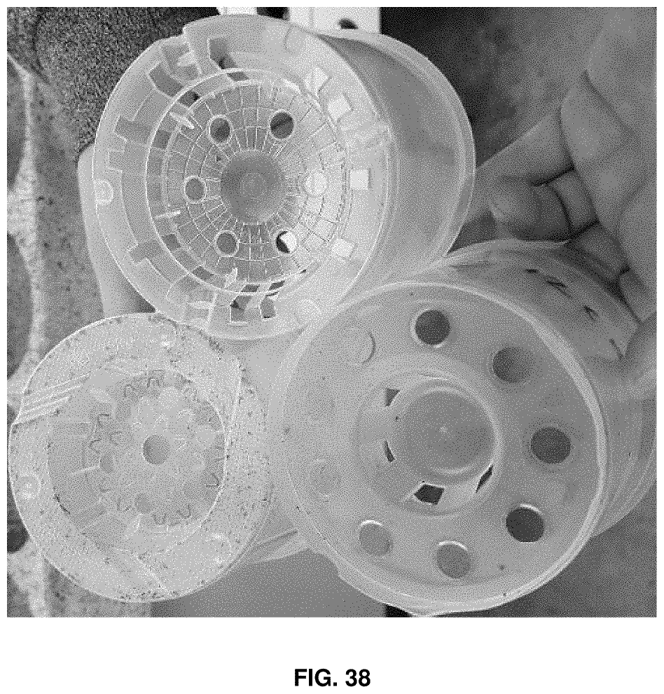

The containers of the systems and methods described herein can be any suitable pots or other containers conducive for plant growth, such as cavities in a tray. Non-limiting examples of suitable pots are shown in the photograph in FIG. 38. The pots shown in FIG. 38 are made of a plastic material and include holes for drainage. Other non-limiting example pots are disclosed in U.S. Application Publication Number 20180000017 A1, which is incorporated herein by reference in its entirety. The container may be composed of plastic or a biodegradable material, and may include holes for drainage in the bottom of the container. The container may also include features such as a center plug on the bottom to help with drainage. Growers use different types of pots for different applications; by having a curved or bendable wrap, or curved or bendable wrap segments cut out from a carpet, it is possible to design fitted components for any type of pot. Optionally, the system can even include a bottom, circular wrap segment placed underneath the plug within the container, depending on the type of container used. A wide variety of plant pots are known and encompassed within the scope of the present disclosure. Especially suitable plant pots are those which are designed for use with orchids.

Though orchids are often mentioned herein for exemplary purposes, the present disclosure is not limited to use with orchids. Rather, a system for plant propagation as described herein can be employed with any plant. Orchids are described herein because for tissue culture orchids, the transition period for root development is critical. The large fleshy roots of an orchid (shown in FIG. 27) are fragile, and handling can easily break and cause transplanting shock, which can be detrimental to plant growth. Therefore, the present disclosure is especially useful with orchids. Better moisture content for the orchid may be achieved, and significantly better growth (relative to just bark), often with an extra pair of leaves which may generate an extra flower stem, has been observed using the systems described herein with orchids. Ultimately, the systems described herein allow for the production of jumbo plugs in a manner that saves on materials, and provide an improved propagation environment which reduces the risk of transplantation shock and associated problems.

It is understood that the present disclosure can be embodied as part of a kit or kits. A non-limiting example of such a kit comprises a plug, a wrap or wrap segments, and a container in two or more packages or housings, where the packages or housings may or may not be present in a combined configuration. A young plant may be growing in the plug. Many other kits are possible, such as kits further comprising seeds, cuttings, or tissue cultures. One non-limiting example kit further includes orchid tissue cultures. The kits may further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a flash drive. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

Certain embodiments of the systems and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A system for plant propagation comprising:
a plug comprising a first plant growth substrate mix;
a wrap having a first side and a second side and comprising a second plant growth substrate mix, wherein the wrap defines a plurality of slits in the first side; and
a container configured to house the plug with a plant growing therein, wherein the wrap is configured to be wrapped around the plug in the container such that the first side is in direct contact with the plug or roots of a plant growing in the plug.

2. The system of claim 1, wherein the first side is arcuate and the second side is arcuate, the wrap thereby being curved.

3. The system of claim 1, wherein the wrap comprises a single, bendable piece of the second plant growth substrate mix.

4. The system of claim 1, wherein the wrap comprises two or more wrap segments configured to fit together and substantially encircle the plug.

5. The system of claim 1, wherein the first plant growth substrate mix has about 50% identity in composition to the second plant growth substrate mix.

6. The system of claim 1, wherein the first plant growth substrate mix is identical to the second plant growth substrate mix.

7. The system of claim 1, further comprising a circular bottom comprising either of the first plant growth substrate mix or the second plant growth substrate mix, wherein the circular bottom is configured to be disposed in the container below the plug.

8. (canceled)

9. The system of claim 1, wherein at least one of the first plant growth substrate mix or second plant growth substrate mix comprises peat, coir, pine or other barks, perlite, compost, fertilizers, minerals such as vermiculite, manure, granulated lava, pumice, burnt or calcined clay, mineral fibers, Sphagnum moss, Hypnaceous moss, rice hulls, wood fiber, coir fiber, synthetic fiber, hemp fiber, bagasse, sand, perlite, leaf mold, gypsum, limestone, clay, cellulose fibers, lignocellulose fibers, or combinations thereof.

10. (canceled)

11. The system of claim 1, wherein one of the first or second plant growth substrate mixes comprises a hydrophilic polyurethane prepolymer.

12. The system of claim 11, wherein the hydrophilic polyurethane prepolymer comprises a reaction product of a polyoxyethylene polyol with a polyisocyanate.

13-14. (canceled)

15. The system of claim 1, wherein the slits have a rectangular cross section.

16. The system of claim 1, wherein the slits have a triangular cross section.

17. The system of claim 1, wherein the slits comprise incisions that do not extend fully through a thickness of the wrap.

18. The system of claim 1,
wherein the slits separate rectangular protrusions of the second plant growth substrate mix that extend from the second side to the first side.

19. A system for plant propagation comprising:
a plug comprising a first plant growth substrate mix;
a wrap comprising a plurality of wrap segments comprising a second plant growth substrate mix, each of the plurality of wrap segments having a first side and a second side, the second side of at least one of the plurality of wrap segments comprising a ledge configured to support the plug; and
a container configured to house the plug with a plant growing therein, wherein the wrap segments are configured to be wrapped around the plug in the container such that the first side faces the container and the second side is in direct contact with the plug or roots of a plant growing in the plug.

20. The system of claim 19, wherein the at least one of the plurality of wrap segments has an L-shape.

21. (canceled)

22. The system of claim 6, wherein the wrap consists essentially of the second plant growth substrate mix, and the plug consists essentially of the first plant growth substrate mix.

23-24. (canceled)

25. The system of claim 1, wherein each of the plurality of slits is latitudinal.

26. The system of claim 1, wherein each of the plurality of slits extends across a width of the wrap.

27-31. (canceled)

32. A method for propagating a plant, the method comprising:
growing a plant seedling in a plug comprising a plant growth substrate mix until the plant seedling develops roots protruding from the plug;
surrounding the plug with a wrap comprising the plant growth substrate mix to form a wrapped plug, wherein the wrap comprises a plurality of slits; and
configuring the wrapped plug in a container for further growth of the plant.

33. The method of claim 32, wherein the plant is an orchid.

34-37. (canceled)
